(19) United States
(12) Patent Application Publication
(10) Pub. No.: US 2012/0055013 A1
(43) Pub. Date: Mar. 8, 2012

(54) FORMING MICROSTRUCTURES AND ANTENNAS FOR TRANSPONDERS

(75) Inventor: David Finn, Tourmakeady (IE)

(73) Assignee: Féinics AmaTech Nominee Limited, Tourmakeady (IE)

(21) Appl. No.: 13/294,578

(22) Filed: Nov. 11, 2011

Related U.S. Application Data
(63) Continuation-in-part of application No. 13/027,415, filed on Feb. 15, 2011.
Application No. 13/027,415 is a continuation-in-part of application No. 13/224,351, filed on Sep. 2, 2011.
Application No. 13/224,351 is a continuation-in-part of application No. 12/901,590, filed on Oct. 11, 2010.
Application No. 12/901,590 is a continuation-in-part of application No. 13/205,600, filed on Aug. 8, 2011.
(60) Provisional application No. 61/363,763, filed on Jul. 13, 2010.
(60) Provisional application No. 61/511,990, filed on Jul. 27, 2011.
(60) Provisional application No. 61/533,228, filed on Sep. 11, 2011.
(60) Provisional application No. 61/536,153, filed on Sep. 19, 2011.
(60) Provisional application No. 61/413,438, filed on Nov. 13, 2010.

(51) Int. Cl. H01P 11/00

(52) U.S. Cl. 29/600

(57) ABSTRACT

Microstructures such as connection areas, contact pads, antennas, coils, plates for capacitors and the like may be formed using nanostructures such as nanoparticles, nanowires and nanotubes. A laser may be used to assist in the process of microstructure formation, and may also be used to form other features on a substrate such as recesses or channels for receiving the microstructures. A smart mobile phone sticker (MPS) mounted to a cell phone with a self-sticking shielding element comprising a core layer having ferrite particles.

### TECHNICAL FIELD

The invention relates to the production of security documents such as electronic passports and smart cards having an RFID (radio frequency identification) chip module and one or more substrate layers, and more particularly to techniques for forming metallic or ferrous structures such as antenna conductors or electromagnetic shields in the security documents.

### BACKGROUND

Transponders are electronic devices incorporated into secure documents such as “smart cards” and “electronic passports” using RFID (radio frequency identification) technology. The transponder (or “inlay”, or “chip card”) itself generally comprises (includes):
a substrate (“inlay” substrate”) which may comprise a sheet of a synthetic material;
a, RFID chip or chip module installed in a recess in a surface of the substrate; and
an antenna wire mounted on the substrate, formed with “turns” as a flat coil and connected by its two ends or end portions to corresponding two terminals of the chip module.

U.S. Pat. No. 6,698,089, incorporated by reference herein, discloses a conventional exemplary method to produce a transponder containing a high frequency RFID chip (or chip module) and an antenna embedded into a multi-layer substrate and connected to the terminal areas of the RFID chip. In a first “mounting stage”, an end of an antenna wire is embedded into a top substrate layer with an end segment of the antenna wire oriented in the direction of the RFID chip residing in a recess and supported by a lower substrate layer. Then an end portion of the antenna wire is guided over a first terminal area of the RFID chip. Then, on the opposite side of the RFID chip (and after bridging the recess), the embedding process continues by countersinking the antenna wire into the top substrate layer to form an antenna with a specific number of turns. Then the antenna wire is guided over the second terminal area (again, bridging the recess). Finally, a short end segment of wire (including the end) is embedded into the top substrate layer before cutting the wire to complete the high frequency transponder site. After the mounting stage is completed, the tooling is changed and next, in a “connecting stage”, the end portions (“connection portions”) of the wire passing over the terminals of the RFID chip are interconnected thereto, typically by thermal compression bonding.

### An Inlay and Transponder of the Prior Art

FIGS. 1A and 1B illustrate an inlay substrate (or sheet) 100 having a plurality of transponder areas. A selected one of the transponder areas 102 constituting a single transponder is shown in detail. The vertical and horizontal dashed lines (in FIG. 1A) are intended to indicate that there may be additional transponder areas (and corresponding additional transponders) disposed to the left and right of, as well as above and below, the transponder area 102, on the inlay sheet 100. Such a plurality of transponders may be arranged in an array on the (larger) inlay sheet. As best viewed in FIG. 1B, the inlay sheet 100 may be a multi-layer substrate 104 comprising one or more upper (top) layers 104a and one or more lower (bottom) layers 104b.

A recess 106 may be formed in (through) the upper layer 104a, at a “transponder chip site”, so that a transponder chip 108 may be disposed in the recess, and supported by the lower layer 104b. The transponder chip 108 is shown having two terminals 108a and 108b on a top surface thereof. The transponder chip 108 may be a chip module, or an RFID chip.

Generally, the recess 106 is sized and shaped to accurately position the transponder chip 108, having side dimensions only slightly larger than the transponder chip 108 to allow the transponder chip 108 to be located within the recess. For example,
1. the transponder chip 108 may measure: 5.0×8.0 mm
2. the recess 106 may measure: 5.1×8.1 mm
3. the terminals 108a/b may measure: 5.0×1.45 mm
4. the wire (discussed below) may have a diameter between 60 and 112 μm

One millimeter (mm) equals one thousand (1000) micrometers (μm, “micron”).

In FIGS. 1A and 1B, the recess 106 may be illustrated with an exaggerated gap between its inside edges and the outside edges of the chip 108, for illustrative clarity. In reality, the gap may be only approximately 50 μm-100 μm (0.05 mm-0.1 mm).

In FIG. 1A the terminals 108a and 108b are shown reduced in size (narrower in width), for illustrative clarity. (From the dimensions given above, it is apparent that the terminals 108a and 108b can extend substantially the full width of the transponder chip 108.)

It should be understood that the transponder chip 108 is generally snugly received within the recess 106, with dimensions suitable that the chip 108 does not move around after being located within the recess 106, in anticipation of the wire ends 110a, 110b being bonded to the terminals 108a, 108b. As noted from the exemplary dimensions set forth above, only very minor movement of the chip 108, such as a small fraction of a millimeter (such as 50 μm-100 μm) can be tolerated.

As best viewed in FIG. 1A, an antenna wire 110 is disposed on a top surface (side) of the substrate, and may be formed into a flat (generally planar) coil, having two end portions 110a and 110b.

As best viewed in FIG. 1B, the antenna wire is “mounted” to the substrate, which includes “embedding” (countersinking) the antenna wire into the surface of the substrate, or “adhesively placing” (adhesively sticking) the antenna wire on the surface of the substrate. In either case (embedding or adhesively placing), the wire typically feeds out of a capillary 116 of an ultrasonic wire guide tool (not shown). The capillary 116 is typically disposed perpendicular to the surface of the substrate 100. The capillary 116 is omitted from the view in FIG. 1A, for illustrative clarity.

The antenna wire 110 may be considered “heavy” wire (such as 60 μm-112 μm), which requires higher bonding loads than those used for “fine” wire (such as 30 μm). Rectangular section copper ribbon (such as 60×30 μm) can be used in place of round wire.

The capillary 116 may be vibrated by an ultrasonic vibration mechanism (not shown), so that it vibrates in the vertical or longitudinal (z) direction, such as for embedding the wire in the surface of the substrate, or in a horizontal or transverse (y) direction, such as for adhesively placing the wire on the surface of the substrate. In FIG. 1B, the wire 110 is shown slightly spaced (in drawing terminology, “exploded” away) from the substrate, rather than having been embedded (countersunk) in or adhesively placed (stuck to) on the surface of the substrate.

The antenna wire 110 may be mounted in the form of a flat coil, having two ends portions 110a and 110b. The ends portions 110a and 110b of the antenna coil wire 110 are shown extending over (FIG. 1A) and may subsequently be connected, such as by thermo-compression bonding (not shown), to the terminals 108a and 108b of the transponder chip 108, respectively.

Examples of embedding a wire in a substrate, in the form of a flat coil, and a tool for performing the embedding (and a discussion of bonding), may be found in the aforementioned U.S. Pat. No. 6,698,089 (refer, for example, to FIGS. 1, 2, 4, 5, 12 and 13 of the patent). It is known that a coated, self-bonding wire will stick to a synthetic (e.g., plastic) substrate because when vibrated sufficiently to soften (make sticky) the coating and the substrate.

In FIG. 1B, the wire 110 is shown slightly spaced (in drawing terminology, “exploded” away) from the terminals 108a/b of the transponder chip 108, rather than having been bonded thereto, for illustrative clarity. In practice, this is generally the situation—namely, the end portions of the wires span (or bridge), the recess slightly above the terminals to which they will be bonded, in a subsequent step. Also illustrated in FIG. 1B is a “generic” bond head, poised to move down (see arrow) onto the wire 110b to bond it to the terminal 108b. The bond head 118 is omitted from the view in FIG. 1A, for illustrative clarity.

The interconnection process can be innerlead bonding (diamond tool), thermo-compression bonding (thermode), ultrasonic bonding, laser bonding, soldering, ColdHeat soldering (Athalite) or conductive gluing.

As best viewed in FIG. 1A, in case the antenna wire 110 needs to cross over itself, such as is illustrated in the dashed-line circled area “c” of the antenna coil, it is evident that the wire should typically be an insulated wire, generally comprising a metallic core and an insulation (typically a polymer) coating. Generally, it is the polymer coating that facilitates the wire to be “adhesively placed” on (stuck to) a plastic substrate layer. (It is not always the case that the wire needs to cross over itself. See, for example, FIG. 4 of U.S. Pat. No. 6,698,089).

In order to feed the wire conductor back and forth through the ultrasonic wire guide tool, a wire tension/push mechanism (not shown) can be used or by application of compressed air it is possible to regulate the forward and backward movement of the wire conductor by switching the air flow on and off which produces a condition similar to the Venturi effect.

By way of example, the wire conductor can be self-bonding copper wire or partially coated self bonding copper wire, enamel copper wire or partially coated enamel wire, silver coated copper wire, un-insulated wire, aluminum wire, doped copper wire or litz wire.

Several improvements and variations to the techniques for mounting an antenna to an inlay substrate and connecting it with a chip module are disclosed herein.

### SUMMARY

Microstructures such as connection areas, contact pads, antennas, coils, plates for capacitors and the like may be formed using nanostructures such as nanoparticles, nanowires and nanotubes. A laser may be used to assist in the process of microstructure formation, and may also be used to form other features on a substrate such as recesses or channels for receiving the microstructures.

The surface of a substrate may be modified using a laser to be smoother or rougher, or to have recesses or channels, in preparation for forming structures such as electrically-conductive lines (such as for antennas) or areas (such as for capacitors, ferrite shields, etc.). A laser may be used to create channels and/or to modify roughness of the surface locally on synthetic paper materials such as Teslin™.

For example, in preparation for forming an antenna having an elongate pattern of an electrically conductive material such as wire, conductive glue, ink, silver paste, metallic powder/particles and/or nanotubes or nanowires, a pattern corresponding to the desired pattern of the antenna (typically, several turns) may be defined (etched, formed) on the substrate, such as with a channel(s) or by roughing up the surface. The conductive material may then be applied to the substrate. For example, nanostructures (nanoparticles, nanowires, nanotubes, etc.) may preferentially be disposed in the roughed-up pattern. Further processing steps such as sintering or plating may also be performed once the conductive material is in place on or in the substrate. For example, the nanostructures may subsequently be modified using heat or light, including from a laser source or photonic lamp, for example to achieve bonding of nanowires with one another to lower the resistance of a track of nanowires.

Crossovers of the antenna (if required) may be accommodated for example by a deep trench passing under a shallower trench (or the surface of the substrate).

Various techniques may be employed to connect the antenna to a chip or chip module.

Structures other than antennas may be formed using the techniques disclosed herein, such as forming ferrite elements for decoupling or shielding, primarily in the context of RFID documents.

Security features for various documents, including non-RFID documents such as currency may be implemented using some of the techniques disclosed herein. For example, ferrite elements which may be personalized may also be formed.

The various individual features disclosed herein may be combined in various ways with one another for a variety of applications.

Other objects, features and advantages may become apparent in light of the following descriptions of various embodiments of the invention.

### BRIEF DESCRIPTION OF THE DRAWINGS

Reference will be made in detail to embodiments of the disclosure, examples of which may be illustrated in the accompanying drawing figures (FIGs). The figures are intended to be illustrative, not limiting. In some of the figures, certain elements may be omitted or exaggerated, or shown “exploded” (spaced apart) from other elements, for illustrative clarity. Although the invention is generally described in the context of these embodiments, it should be understood that it is not intended to limit the invention to these particular embodiments.

FIG. 1A is a top view of a transponder, according to the prior art.

FIG. 1B is a cross-sectional view taken on a line 1B-1B through FIG. 1A.

FIG. 2A is a perspective view of a laser forming a feature which is a recess in a substrate, according to some embodiments of the invention.

FIGS. 2B, 2C are cross-sectional views illustrating forming recesses in substrates, according to some embodiments of the invention.

FIGS. 3A, 3B, 3C are cross-sectional views illustrating forming channels in substrates, according to some embodiments of the invention.

FIG. 3D is a diagram illustrating a channel having a pattern of turns for an antenna, according to some embodiments of the invention.

FIG. 3E is a top view of channels extending from a recess, according to some embodiments of the invention.

FIG. 3F is a perspective view of channels crossing over one another in a substrate, according to some embodiments of the invention.

FIG. 3G, 3H, 3I are top views of ditches and bridges formed in a substrate, according to some embodiments of the invention.

FIGS. 3J, 3K, 3L are cross-sectional views of channels, according to some embodiments of the invention.

FIGS. 4A,4B are cross-sectional views of channels in a substrate, and wires laid in the channels, according to some embodiments of the invention.

FIGS. 4C, 4D are cross-sectional views of channels in a substrate, and filling the channels with a conductive material, according to some embodiments of the invention.

FIGS. 4E, 4F are cross-sectional views of channels in a an adhesive layer on a substrate, and filling the channels with a conductive material, according to some embodiments of the invention.

FIG. 4G is a top view of connecting to channels, according to some embodiments of the invention.

FIG. 4H, 4I, 4J are cross-sectional views of connecting to channels, according to some embodiments of the invention.

FIGS. 5A, 5B, 5C, 5D are cross-sectional views of a technique for using a transfer substrate, according to some embodiments of the invention.

FIGS. 6A, 6B, 6C are cross-sectional diagrams of laser ablation performed on a substrate, according to some embodiments of the invention.

FIGS. 7A, 7B, 7C are perspective views of using a laser to form conductive tracks in a substrate, according to some embodiments of the invention.

FIG. 8 is a perspective view of an apparatus for forming and filling channels with nanoparticles, according to some embodiments of the invention.

FIG. 9A is a top view of a dual interface (DIF) inlay substrate with a flat coil antenna mounted on a surface thereof, for comparison with (and context for) some embodiments of the invention.

FIG. 9B is a top view of an inlay substrate with a flat coil antenna mounted on a surface thereof, according to some embodiments of the invention.

FIG. 9C is a cross-sectional view of the inlay substrate of FIG. 9B, taken on line 9C-9C through FIG. 9B.

FIG. 9D is is a cross-sectional view of the inlay substrate of FIG. 9B, taken on line 9C-9C through FIG. 9B.

FIG. 9E is a cross sectional view of a secure document, according to some embodiments of the invention.

FIG. 9F is a cross sectional view of a secure document, according to some embodiments of the invention.

FIG. 10A is a perspective view of a technique for mounting and connecting an antenna wire to a chip module of a transponder, according to some embodiments of the invention.

FIG. 10B is a cross-sectional view taken on a line 10B-10B through FIG. 10A.

FIG. 10C is a top view of a further step in the technique of FIG. 10A.

FIG. 10D is a perspective view of a patch for insertion into a card body, illustrating some embodiments of the invention.

FIG. 10E is a perspective view of a card body of a secure document, incorporating the patch of FIG. 10D, illustrating some embodiments of the invention.

FIG. 11A is an exploded, partial perspective view of a secure document, illustrating some embodiments of the invention.

FIG. 11B is a perspective view of an RFID chip which may be used in a secure document, according to some embodiments of the invention.

FIG. 12A is a cross-sectional view of a dual interface (DIF) card, according to some embodiments of the invention.

FIG. 12B is a cross-sectional view of a technique for applying a mobile phone sticker (MPS) to a cell phone, according to some embodiments of the invention.

FIG. 12C is a cross-sectional view of a shielding element used in the technique for applying a mobile phone sticker (MPS) to a cell phone, according to some embodiments of the invention.

### DETAILED DESCRIPTION

Various “embodiments” of the invention (or inventions) will be discussed. An embodiment is an example or implementation of one or more aspects of the invention(s). Although various features of the invention(s) may be described in the context of a single embodiment, the features may also be provided separately or in any suitable combination. Conversely, although the invention(s) may be described herein in the context of separate embodiments for clarity, the invention(s) may also be implemented in a single embodiment.

The relationship(s) between different elements in the figures may be referred to by how they appear and are placed in the drawings, such as “top”, “bottom”, “left”, “right”, “above”, “below”, and the like. It should be understood that the phraseology and terminology employed herein is not to be construed as limiting, and is for descriptive purposes only.

The invention relates generally to inlays and techniques for making the inlays, including technical features and security features. As used herein, an “inlay” may be a single- or multi-layer substrate containing HF (high frequency) and/or UHF (ultra-high frequency) radio frequency identification (RFID, transponder) chips and/or modules. These inlays may be used in secure documents, such as, but not limited to, electronic passports (ePassports) and electronic ID (eID) cards, mobile phone stickers and the like.

The following embodiments and aspects thereof may be described and illustrated in conjunction with systems, tools and methods which are meant to be exemplary and illustrative, not limiting in scope. Specific configurations and details may be set forth in order to provide an understanding of the invention. However, it should be apparent to one skilled in the art that the invention(s) may be practiced without some of the specific details being presented herein. Furthermore, well-known features may be omitted or simplified in order not to obscure the descriptions of the invention(s).

Various embodiments of the invention will be presented to illustrate the teachings of the invention(s). In the main, examples of electronic passport covers with inlay substrates having leadframe modules may be used to illustrate the embodiments. It should be understood that various embodiments of the invention(s) may also be applicable to other secure documents containing electronics (such as RFID and antenna), such as electronic ID cards. Secure documents may also be referred to as “electronic documents”. In the main hereinafter, secure documents which are passport inlays, typically cold laminated (with adhesive), are discussed.

### Forming Recesses Using Laser Ablation

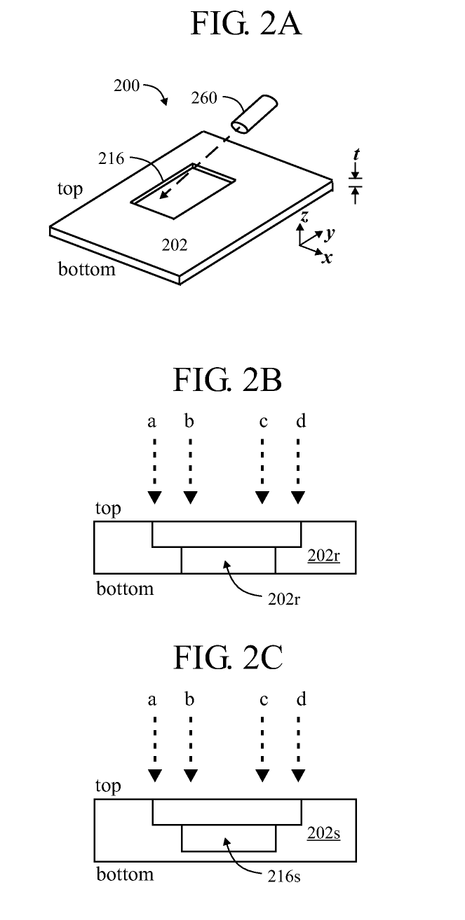

FIGS. 2A-2C illustrate various techniques for using a laser to ablate material in a controlled manner from a substrate, such as an inlay substrate, to form a recess extending into a surface of the inlay substrate, for various purposes such as may be disclosed herein.

FIG. 2A illustrates an exemplary process 200 of forming a recess 216 in an inlay substrate 202, using a laser 260. The inlay substrate 202 may be a single layer of Teslin (for example), having a thickness “t” of 356 μm. A typical size (width dimensions) for the recess 216, to accommodate a chip module with a lead frame, may be approximately 5 mm×8 mm. The recess 216 may extend completely through the inlay substrate 202, resulting in a “window-type” recess. The recess 216 may extend only partially, such as 260 μm through the inlay substrate 208, resulting in a “pocket-type” recess.

The laser 260 emits a beam (dashed line), targeted at the substrate 202, to ablate material from the substrate 208 to form the recess 216. The beam may have a diameter of approximately 0.03 mm (30 μm). The beam may be scanned back and forth, traversing in one direction entirely across the recess area, turning around, and traversing back across the recess area, like plowing a field. Many passes may be required to carve out the entire area of the recess, given that the beam diameter is typically much (such as 10-100 times) smaller than the length or width of the recess. The beam may be scanned, in any suitable manner, such as with minors (galvanometer scanning head). Also, the intensity of the beam may be controlled or modulated to control the penetration into the substrate. For example, a pulse-width modulated beam may be used. The laser may be a UV, VIS or IR laser (193 nm to 1030 nm) with a power ranging from 5 to 70 watts, depending on the attenuation of the harmonic box for a particular wavelength. The shape of the laser beam can be Gaussian or top hat. Alternatively, a constant wave laser beam from a CO₂ laser operating at a wavelength of 10640 nm with a power ranging from 40 to 300 watts can achieve the same performance as a pulse modulated laser source. The ablation mechanism can be photochemical, photothermal, photomechanical or a combination thereof.

The process of using a laser in this manner, rather than (for example) a conventional rotating milling tool, may be referred to as “laser milling”. The technique described herein may be particularly beneficial for applications where it is desired to form a “pocket” type recess which intentionally does not extend all the way through the substrate or sheet (in other words, the recess or pocket extends only partially through the substrate). Mechanical milling can be difficult. On the other hand, laser milling can be very effective for Teslin™ and polycarbonate substrates. For PVC, laser milling is less effective.

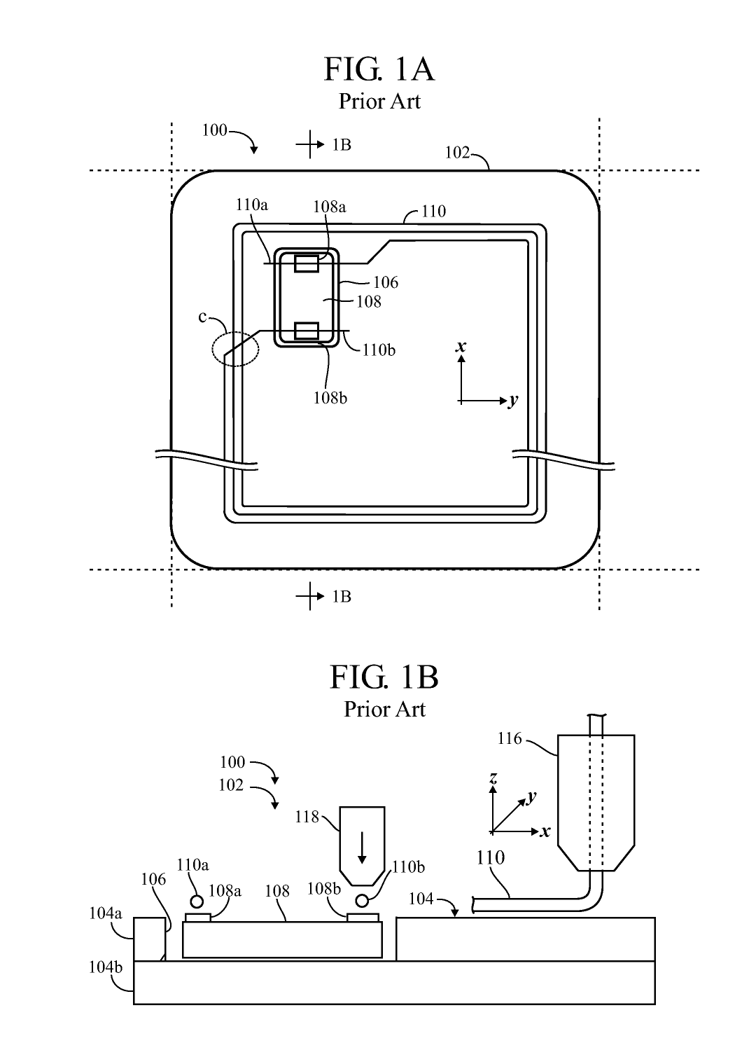

The recess (opening) 216 formed in the inlay substrate layer 208 of FIG. 2A extends completely through the inlay substrate layer 208. The layer may be representative of each of the at least two inlay substrate layers 104a and 104b shown in FIG. 1B. Rather than having straight sidewalls, the recess may have stepped sidewalls, with two different-size openings formed therein, as follows.

FIG. 2B shows forming a stepped window-type recess 216r in a single layer of material, such as a layer of Teslin™ for an inlay substrate 202r, using laser ablation. This may be a two-step process comprising:
first laser milling a central area (such as between “b” and “c”) to a first partially through the substrate,
then continuing laser milling the entire area (such as between “a” and “c”) to create a recess extending partially through the substrate in a peripheral area, and to extend the recess in the central area completely through the substrate.

### Alternatively:

first laser milling the entire area (between “a” and “d”) to a first depth (d1)
then laser milling only the central area (between “b” and “c”) to a second depth (d2).

FIG. 2C shows forming a stepped pocket-type recess 216s in a single layer of material, such a layer of Teslin™ for an inlay substrate 208s, using laser ablation. This may be a two-step process comprising:
first laser milling a central area (such as between “b” and “c”) to a depth partially through the substrate,
then continuing laser milling the entire area (such as between “a” and “d”) to create a recess extending partially through the substrate in a peripheral area, and to extend the recess in the central area deeper into (but not completely through) the substrate.

### Alternatively:

first laser milling the entire area (between “a” and “d”) to a first depth (d1)
then laser milling the central area (between “b” and “c”) to a second depth (d2).

### Forming Channels in Inlay Substrates, for Mounting the Antenna Wire

As mentioned above, the antenna wire may be mounted to the surface of an inlay substrate by ultrasonically embedding (countersinking) it into the surface of the inlay substrate. Ideally, the antenna wire is fully embedded so that it is flush or below the top surface of the inlay substrate.

With ultrasonic embedding, the wire may become only partially embedded, such as approximately half its diameter. In other words, a 100 μm diameter wire may be embedded 50 μm (half its diameter) into the inlay substrate, and may protrude approximately 50 μm (half its diameter) from the surface of the inlay substrate. And, in the case of adhesively sticking, a 100 μm diameter wire may be substantially not embedded at all into the inlay substrate, and may protrude approximately 100 μm (its entire diameter) from the surface of the inlay substrate.

For applications such as driver's license or passports, it is generally not desirable that the wire extend (protrude) above the surface of the inlay substrate. As discussed hereinabove, the chip module may be recessed so as to be substantially contained within the inlay substrate (or sheet), without sticking out and creating a bump.

According to an embodiment of the invention, the antenna wire may be mounted so as to be substantially entirely disposed (embedded) within the surface of the inlay substrate, without protruding therefrom. In other words, the wire will be substantially entirely recessed below the surface of the inlay substrate.

Generally, this may be accomplished by creating a “groove” (or “channel”, or “trench”) in the surface of the inlay substrate to accept the antenna wire. Then, the antenna wire may then be laid (inlaid, pressed, sunk) into the groove.

In general, the groove may be formed either by removing material from the substrate (by analogy, digging a trench with a shovel, and tossing the dirt aside), or displacing material of the substrate (by analogy, hoeing a trench to push aside dirt). Some exemplary techniques for removing or displacing material will be described below. A mechanical tool, such as a wire bonder, may be used to form and press the wire into the groove.

The depth of the groove should be at least a substantial portion of the diameter of the wire, such as at least 50% of the diameter of the wire, including at least 60%, at least 70%, at least 80% and at least 90%, and the groove may be at least as deep as the wire diameter, such as at least 100%, at least 105%, at least 110%. In some cases, described below, the groove may be a “deep trench” which is much greater than the diameter of the wire, for routing the wire from one level, such as just within the surface of the substrate to another level, such as deep within the substrate, such as for facilitating connecting the wire to contact areas or pads of a module which are disposed below the surface of the substrate.

For example, for mounting a 60 μm diameter wire, a groove which is approximately 60 μm deep may be formed into the surface of the inlay substrate. As discussed below, in conjunction with mechanically embedding the antenna wire in the groove, heat may be applied to allow further embedding. Therefore, for example, a 60 μm wire could be pressed, with heat, into a 40 μm deep groove, and become substantially entirely embedded within the surface of the substrate, without protruding therefrom.

The groove may be less deep than the diameter of the wire and, as the wire is laid down into the groove, it may be pressed further into the substrate. Or, after the entire antenna wire is laid down, the inlay substrate may be placed in a lamination press which may further sink the antenna wire into the inlay substrate. The wire may be warmed. The process may be performed in a warm environment to soften the substrate.

The width of the groove may be approximately equal to the diameter of the wire. For example, for a wire having a diameter of 60-80 μm, a laser beam having a diameter of 0.03 mm (30 μm) would create a groove sufficiently wide (100 μm) to receive the wire. As the width of the laser beam is associated with the irradiation wavelength, the laser may scan the material several times with certain overlap to attain the desired width. The groove may be narrower than the diameter of the wire, such as approximately 95% of the diameter of the wire, to facilitate an “interference” fit, securely holding the wire in position for subsequent handling. In general, a groove which is significantly wider than the diameter of the wire would not be preferred, since it would tend not to retain the wire (such as by interference fit), without more (such as an adhesive).

The groove may be slightly narrower than the diameter of the wire, and as the wire is being laid down, the material of the inlay substrate may resiliently retract (e.g., elastic deformation) to receive the wire, holding it in place. Generally, the wire typically has a circular cross-section (but may have other cross-sections, such as a ribbon wire), and the groove may have a substantially rectangular cross-section. For example, a 60 μm wide groove may receive and retain in place an 80 μm diameter wire. The wire may be warmed as it is being laid down (scribed, sunk) into the groove to facilitate its entry into the groove.

The groove may simply be a channel extending along the surface of the inlay substrate, formed by a mechanical tool (ultrasonic stamp or scribe), or by a hot mold process. Alternatively, the groove may be formed by laser ablation, in a manner similar to how recesses are made.

Generally, the groove facilitates holding the wire in place. For example, a 100 micron diameter wire can be inserted (with some pressure) into a narrower, such as 95 micron wide channel (the depth of the channel should be at least half the diameter of the wire, so that the wire can be embedded “over center”), and will stay in place. It is beneficial that this can be done without requiring an ultrasonic embedding tool. As mentioned above, mounting a wire to the inlay substrate is typically done by ultrasonically embedding the wire into the inlay substrate, or ultrasonically causing a self-bonding wire to adhere to the inlay substrate. The “channeling technique” disclosed herein can proceed faster than the ultrasonic techniques, and sheets can be prepared with wire channels, off-line, then the wire can be installed in a simple embedding machine which does not need ultrasonics.

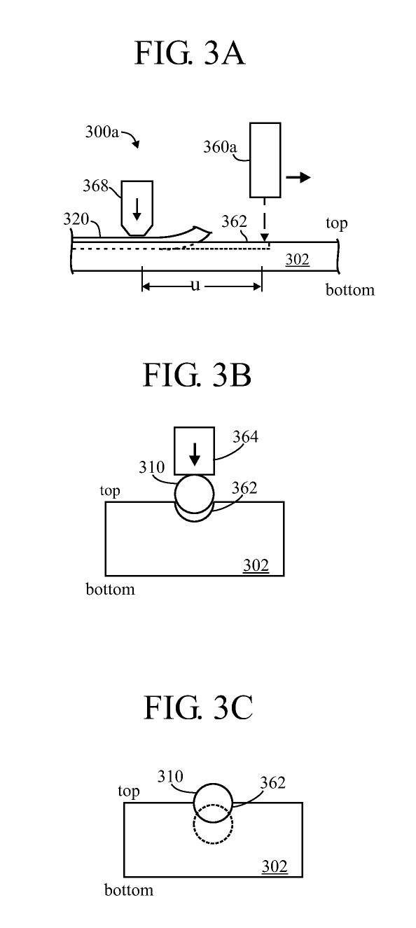

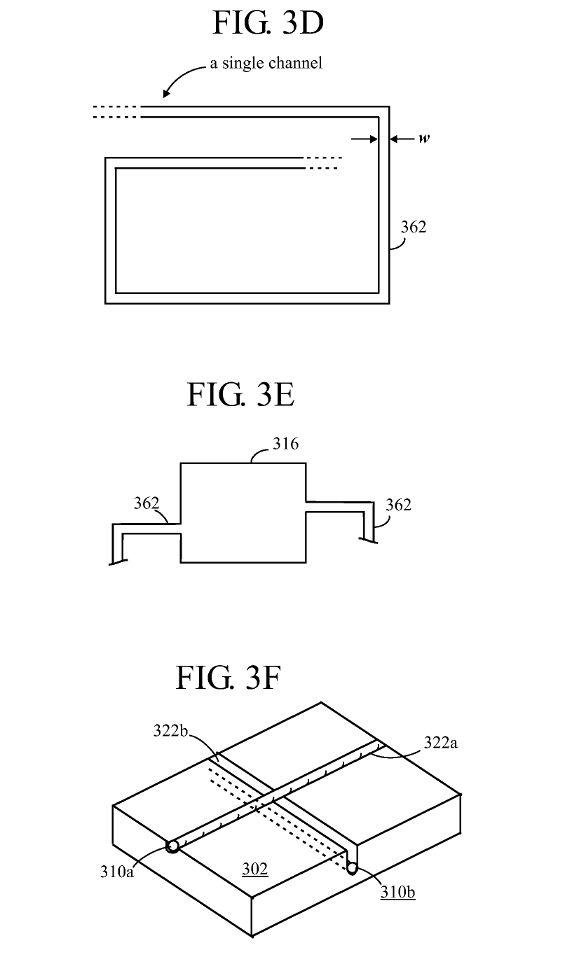

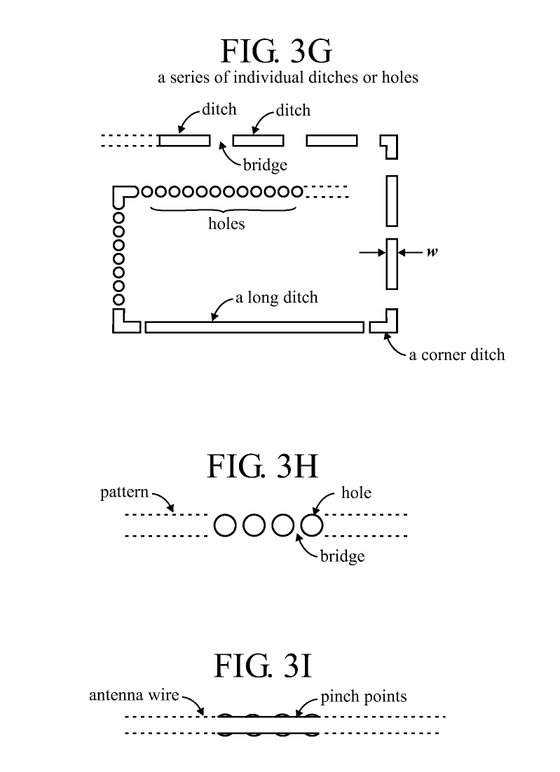

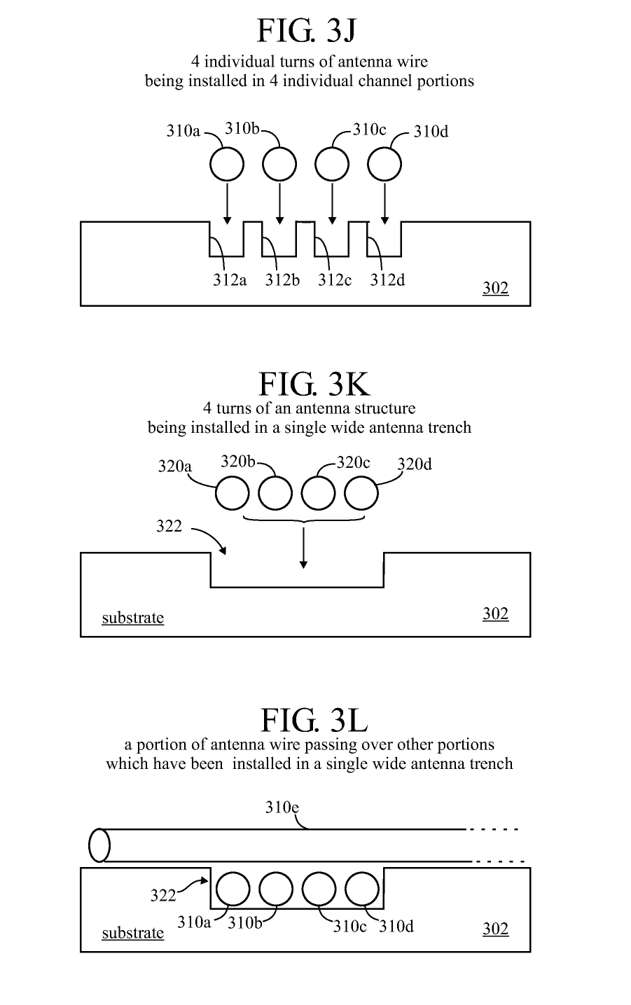

FIG. 3A illustrates a technique 300 using a laser 360 to form a groove (channel, trench) 362 in a surface 302a of an inlay substrate 302. This is an example of removing material to form the groove 362. The laser 360 is shown moving from left-to-right in the figure.

A wire 310 is shown being laid down into the groove 362, from left-to-right, and may be urged into the groove 362 by mechanical means, such as with a simple pressing tool (or wheel) 368. The wire 310 may be laid into the groove 362 during formation of the groove (channel), by following immediately after the laser a short distance “u”. Or, the wire may be laid in the groove later, after an entire groove pattern has been formed in the substrate. Using materials other than wire in the groove to form an antenna are discussed herein.

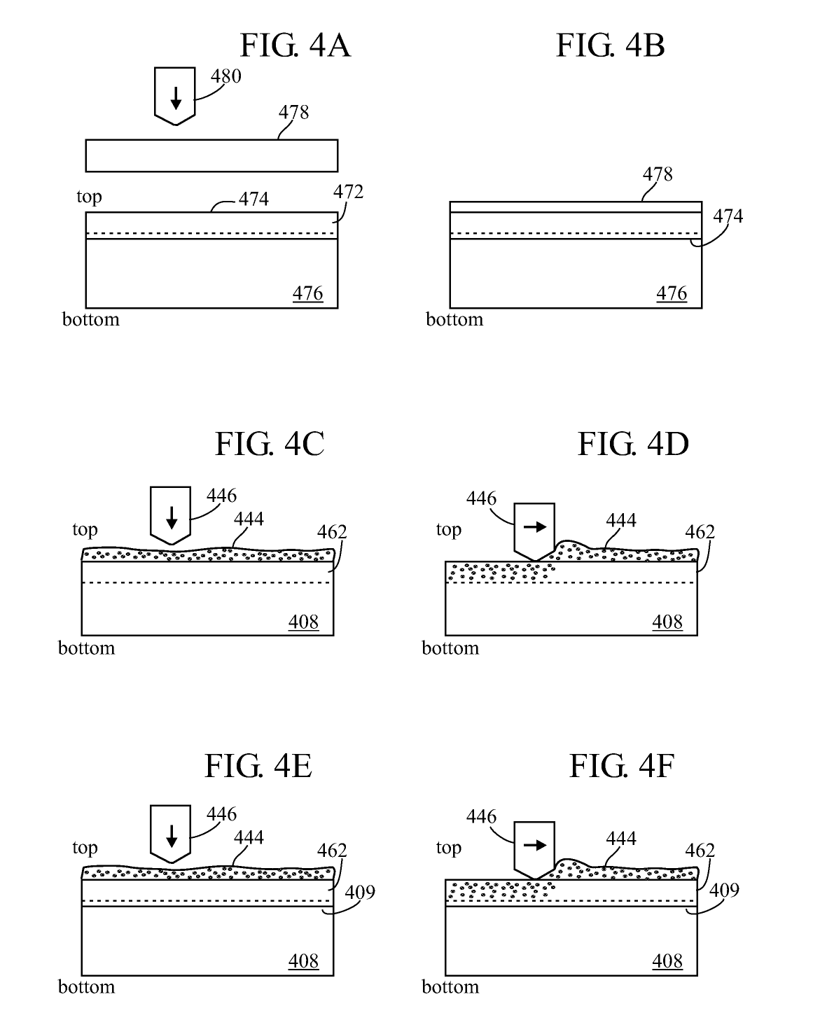

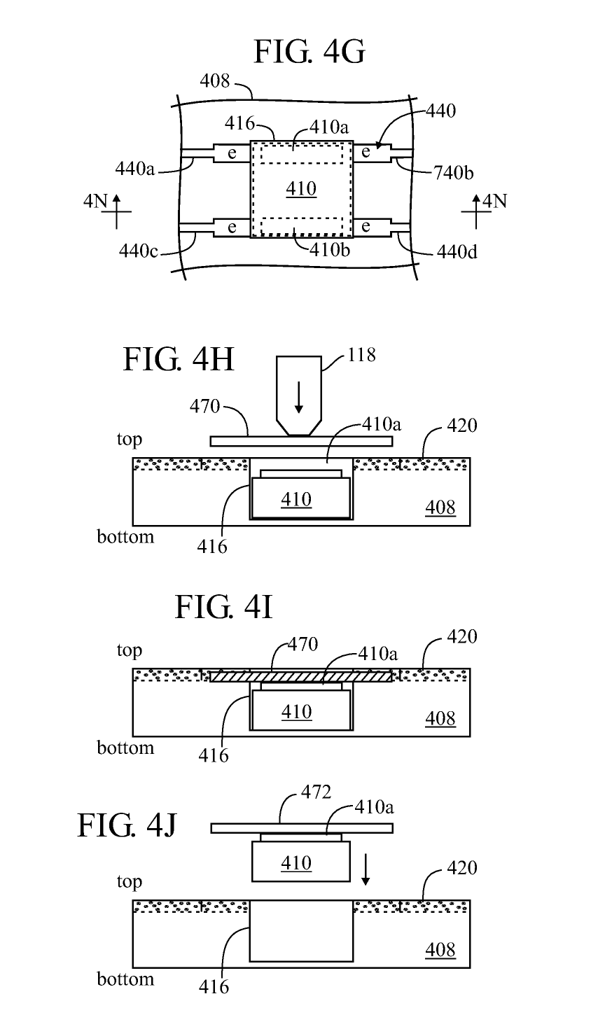

Although only one straight groove is shown, a 2-dimensional (x-y) groove pattern may thus be formed in the top surface of the inlay substrate, extending from (originating and terminating at) a recess in the inlay substrate, for embedding an antenna wire having a number of turns or coils (see FIG. 1A). As mentioned above, insulated wire is relevant where the wire needs to cross over itself, such as at the point “c” in FIG. 1A. And, in some cases, the antenna wire does not need to cross over itself. See, for example, FIG. 4 of U.S. Pat. No. 6,698,089.

It should be understood that the channels for antenna wire being discussed herein are “pre-formed” (prior to mounting/embedding the antenna wire therein) in a desired pattern for the antenna. An inlay substrate may be prepared with such pre-formed channels for later embedding of antenna wire.

It should be understood that when a wire is inserted (mounted) into a pre-formed groove, this is different than ultrasonic embedding into a non-grooved surface of a substrate, such as is disclosed in U.S. Pat. No. 6,698,089. A tool for mounting the wire into a pre-formed groove may or may not be ultrasonic. Although the word “embedding” may be used herein, in conjunction with mounting wires in pre-formed grooves, it should be understood that it is used in its generic sense relating to inserting a first material (such as a wire) into a groove formed in another material (such as the inlay substrate, or a given layer thereof).

FIGS. 3B and 3C are cross-sectional views of a substrate 302 with a groove 362, and a wire 310 being mounted in the groove 362. A simple embedding tool 364 may be used (such as without ultrasonics). FIG. 3B shows the beginning of embedding, in a groove that is not as deep as the wire diameter. The groove may be as deep as, or deeper than the wire diameter. In FIG. 3C, the wire 310 is shown, after embedding, protruding above the top surface of the substrate 302. If sufficient pressure, heat and/or ultrasonic are used during embedding and/or the groove is sufficiently deep, the wire may be fully embedded, flush with the top surface of the substrate. It is generally preferred that the wire be completely embedded below the surface of the substrate, to avoid “witnessing” (being able to see where the wire is through subsequent layers). Fully embedding the wire is indicated by the dashed lines in the figure.

FIG. 3D shows an illustrative portion of a channel formed in a surface of an inlay substrate, in a square spiral pattern, for receiving an antenna wire or being filled with a conductive material. The antenna may ultimately have a flat coil shape, having a few turns. The channel has a width “w” which may be approximately the width of an antenna wire, such as approximately 100 μm (for example), and should extend into the surface of the substrate to a depth which is at least as great as the diameter of the antenna. In this manner, the antenna wire may be disposed in the channel so as to be below the surface of the substrate.

As discussed hereinbelow, rather than forming a channel, per se, a pattern may be formed on the surface of the substrate which has a different texture (such as more rough, or more smooth) than the surrounding surface of the substrate, in preparation for depositing a conductive material on the surface of the substrate, such as to form an antenna from nanostructures (nanoparticles, nanowires, nanotubes).

FIG. 3E shows that a 2-dimensional pattern of channels 362 can be created in a substrate (not shown, such as an inlay substrate), such as using laser ablation or any other suitable process (such as gouging or molding), to accept an antenna wire or conductive material having a number of turns or coils. Two end portions of the channel 362 are shown extending from two opposite edges of a recess 316. The recess 316 may be for a chip module. A recess may also be filled with a conductive material to form an enlarged contact surface or a plate of a capacitor, in which case the channel would only need to extend from one edge of the recess.

FIG. 3F illustrates a method of forming a pattern of channels (or portions of an overall channel) in a substrate 302 (such as an inlay substrate) to accommodate an antenna wire in a situation where the wire needs to cross over itself (such as shown in FIG. 1A), in which case insulated wire may be appropriate. A shallow channel 322a is shown crossing over a deep channel 322b. The channel 322a and 322b may be different portions of one overall channel (322). A wire 310a laid in the shallow channel 322a crosses over a wire 310b laid in the deep channel 322b. The wire 310a and 310b may be different portions of one overall wire (210). Some exemplary dimensions are:
the wire 310 may have a diameter of 80 μm
the channel(s) 322 may have a width of 100 μm
the shallow channel 322a may have a depth of 100 μm
the deep channel 322b may have a depth of 200 μm
the substrate 302 may have a thickness of 350 μm

The wire (or portion) 310b passes under the wire (or portion) 310a, without shorting thereto.

### Ditches and Bridges

According to an embodiment of the invention, the surface of the substrate may be prepared with a plurality or series of “ditches”, or holes which may be formed using laser ablation (or any other suitable process for removing material in a controlled manner from the substrate). In this manner, a significant amount of the inlay substrate material may be removed which would otherwise need to be displaced when embedding (or scribing) the wire into the substrate, such as when using an ultrasonic tool (such as wire guide, described in U.S. Pat. No. 6,233,818). Some examples will be given.

FIG. 3G shows an illustrative portion of an area of the inlay substrate prepared with a series of ditches arranged in a square spiral pattern, for receiving an antenna wire. The antenna may ultimately have a flat coil shape, having a few turns. The ditches may have a width “w” which is approximately the width of the antenna wire, such as approximately 100 μm (for example), and should extend into the surface of the substrate to a depth which is at least as great as the diameter of the antenna.

Between ditches are “bridges” of substrate material which has not been modified (is not ablated). For example, a ditch may have a length of approximately 1 cm, followed by a bridge of substrate material having a length of approximately 1 mm, followed by the next ditch, and so forth. At the top of the pattern, three ditches are shown, separated by two bridges.

As illustrated (as an alternative) in FIG. 3G, the ditches may be substantially longer than 1 cm, in which case they may be considered to be “long ditches”.

As illustrated (as an alternative) in FIG. 3G, the ditches may alternatively have a length which is approximately equal to their width, in which case they may be considered simply to be holes. A portion of the antenna pattern is shown as being a sequence or series of holes, each having a diameter of approximately 100 μm (in this example), and separated by bridges.

Special ditches may be formed at the corners of the antenna pattern to facilitate the wire making the turn when it is being scribed into the inlay substrate.

The ditches (in any of the varieties described above) should extend into the substrate to a depth which approximately equal to the diameter of the wire, or deeper. A typical substrate may have a thickness of approximately 356 μm, and can easily accommodate ditches having a depth of 100 μm.

The bridges between adjacent ditches (of any variety described above) should be as short as possible. When using an ultrasonic embedding tool (such as capillary and sonotrode), when scribing or embedding the wire into the inlay substrate, following the pattern established by the ditches, the bridges will readily be displaced (or collapse).

In the case of laser-drilled holes (such as for the hole variety of ditches), the holes can be drilled at an angle, rather than perpendicular to the surface of the substrate, which will “undermine” the bridges between adjacent holes, facilitating their collapse.

FIG. 3H shows an illustrative portion of an inlay substrate prepared with a pattern of ditches in the form of holes. For illustrative clarity, the holes are illustrated having a diameter which is slightly greater than the diameter of the wire which will be scribed into the substrate. This is also possible in practice, for example, hole diameter 110 μm, wire diameter 100 μm

FIG. 3I shows the same portion of an inlay substrate prepared with a pattern of holes, after an antenna wire has been scribed into the surface of the inlay substrate. Note that where the bridges were (and are now collapsed as a result of the embedding process), the antenna wire is held in place by an interference type fit, at “pinch points” between the holes. This may advantageously obviate the need for using self-bonding wire.

Wide Channels (Trenches) For Accepting An Antenna Structure As described hereinabove, channels may be formed for accepting an antenna wire. According to an embodiment of the invention, a wide “antenna trench” (channel, trench, groove) may be formed in the inlay substrate, the trench having a width which is sufficient to accept the several (4 or 5) turns of an the antenna structure. The antenna structure may be formed “off line” (other than on the inlay substrate, such as by radial coil winding, winding a coil according to the flyer principle, scribing or placing a wire on an intermediate medium and forming a coil to be transferred, forming a coil on a spindle (mandrel), punching a metallic foil to form parts of a coil etc.), and then is placed into the wide antenna trench. After installing the antenna structure in the wide antenna trench, connection portions (ends or end portions) of the antenna wire may be connected to the terminals (terminal areas) of the chip module. The wide antenna trench may be formed using laser ablation, and may extend from edges of a recess (which also may be formed by laser ablation) for the chip module.

FIG. 3J shows four individual portions 310a, 310b, 310c, 310d of an antenna wire (310) being inserted into corresponding four individual portions 312a, 312b, 312c, 312d of a channel (312) or channels in a substrate 302. The substrate 302 may be an inlay substrate for a transponder. Each portion of the wire may be inserted (laid) sequentially (turn-by-turn) into the corresponding channel portion as the turns of the antenna are formed on the substrate, such as using a sonotrode tool (such as in the manner that a sonotrode tool is used in U.S. Pat. No. 6,233,818 to lay an antenna wire on an inlay substrate). The channel may be formed by laser ablation.

FIG. 3K shows a single, wide antenna trench (or groove) 322 formed in a substrate 302. The substrate 402 may be an inlay substrate for a transponder. The antenna trench 322 may be several times wider than the diameter (or cross-dimension) of the wire (the wire need not have a round cross-section), so that the single wide antenna trench can accommodate the multiple turns of an antenna structure. The trench (which is essentially a wide channel) may be formed by laser ablation.

An antenna structure (320) having four turns 320a,b,c,d of antenna wire (a flat coil) is shown being disposed (installed into) the wide antenna trench 322. Typically, the turns of the antenna structure would be spaced slightly apart from one another (rather than touching).

The antenna trench may have a width (across the page) which is much wider than the cross-dimension (diameter) of the antenna wire. For four turns of antenna wire, the antenna trench should be at least 4 times wider than the diameter of a given wire (more like 5 times as wide allowing for some spacing between adjacent turns of the wire).

The antenna trench 322 may be “much wider”, such as at least 2 times wider than the cross-dimension (diameter) of the antenna wire (or the like) so that it can accommodate at least two turns of a flat antenna coil structure disposed in the antenna trench. For example, four turns of 80 μm wire, spaced 40 μm apart from one another, in a 450 μm wide antenna trench 322.

The wide antenna trench should have a depth (into the substrate, from a front surface thereof) which is approximately equal to the diameter of the wire so that the flat coil of the antenna structure will be recessed at least flush within the trench, not protruding above the front surface of the substrate after it is installed.

The turns of the antenna structure may be laid (scribed) into the trench sequentially (turn-by-turn) using a sonotrode tool (such as in the manner that a sonotrode tool is used in U.S. Pat. No. 6,233,818 to lay an antenna wire on an inlay substrate). Alternatively, the antenna structure can be preformed, and disposed as a single unit into the wide trench. In conjunction with laying the antenna in the trench (whether turn-by-turn or as a single unit), connection portions (ends, end portions) of the antenna being formed in the trench may be connected to terminals of the chip module.

Connection portions (ends, end portions) of a preformed antenna structure wire may be connected to terminals of the chip module (not shown) prior to installing the antenna in the trench, or the antenna wire may be connected to the terminals of a chip module previously installed in the substrate.

Glue may be dispensed in the antenna trench the width of an antenna, and wire embed or place an antenna into the antenna trench.

The trench to accept an antenna structure may be partially filled with adhesive. Alternatively, a layer of adhesive could be disposed over the entire area of the inlay substrate covering the trench for the antenna structure and the recess for the chip module. In placing the chip or chip module in its laser ablated recess, the adhesive would act as an anti-fretting medium to reduce the risk of micro-cracking especially in polycarbonate (PC) cards.

As an alternative to using wire, copper foil(s), such as punched (stamped) metallic foils may be laid into the antenna trench. A ribbon may be used.

A process involving the selective deposition and formation of copper layers is described at http://www.kinegram.com/kinegram/com/home.nsf/contentview/˜kinegram-rfid

FIG. 3L shows a single, wide antenna trench (or groove) 322 formed in a substrate 302. The substrate 302 may be an inlay substrate for a transponder. Four portions 310a, 310b, 310c, 310d of an conductor (310) are shown installed in the trench 322. The antenna conductor (310) may comprise wire. Alternatively, the antenna conductor (310) may comprise tracks or traces of conductive material (other than wire) disposed in the trench. In either case, the wire or conductive material of the antenna disposed within the trench are suitably disposed below the surface of the substrate.

Another portion 310e of the wire (or conductive trace) extends along the surface of the substrate 302 (the trace is shown slightly separated from the substrate, for illustrative clarity), and passes over the other portions 310a-310d of the antenna conductor (310) without shorting thereto (compare FIG. 1A, crossover “c”).

### Forming Channels in an Adhesive Layer

FIGS. 4A and 4B illustrate that a channel 472 forming an antenna pattern may be formed in a layer 474 of adhesive on the surface of an inlay substrate 476 or layer of a multi-layer inlay substrate, and a wire 478 may be mounted therein using a tool 480. For example, the adhesive 474 may be 80 μm thick glue. The channel (groove, trench) 472 may be, for example, 60-80 μm deep. The channel 472 may go all the way through the adhesive 474, and further into the substrate 476. The channel 472 may extend only partially through the adhesive 474, as indicated by the dashed line at the bottom of the channel 472.

The adhesive 474 may be polyurethane. Polyurethane, once beyond its “open time”, goes hard, making it ideal for trench formation. Later, for laminating, it may be reactivated with a heat source, such as an infrared light. Hence, the adhesive may be applied sufficiently in advance of channel formation, such as 1-10 minutes (for example) before, to facilitate channel formation.

Filling the Channels with Conductive Material

Channels formed in an inlay substrate or in an adhesive layer on an inlay substrate may be filled with a flowable, conductive material rather than laying (mounting) a wire therein. FIG. 4C illustrates a substrate 408 having a channel (groove, trench) 462 formed in a top surface thereof, and a quantity of flowable, conductive material 444 applied on the surface. Some of the material 444 may be in the channel 462. The conductive material 444 is viscous, such as metallic powder, conductive glue (see list above). A squeegee 446 is shown positioned above the material 444. The squeegee 446 will be lowered (see arrow) so as to be substantially in contact with the top surface of the substrate 408.

Exemplary (non-limiting) dimensions for the channel(s) 462 may be
60-80 μm deep
having a width of, for example, 50-100 μm.

FIG. 4D illustrates that as the squeegee 446 is advanced (see arrow), it forces the conductive material 444 into the channel 462. Residual conductive material 444 is substantially cleared from the surface of the substrate 408, but an additional cleaning step may be added.

FIGS. 4Eand 4F are similar to FIGS. 4C and 4D, and show that the channels can be formed in a layer 409 of adhesive on the surface of the substrate 408 and filled with conductive material 444. In this example, the adhesive 409 is 80 μm thick glue. The channel (groove, trench) 462 may be, for example, 60-80 μm deep. The channel 462 may go all the way through the adhesive 409, and further into the substrate 608.

The adhesive 409 may be polyurethane. Polyurethane, once beyond its “open time”, goes hard, making it ideal for trench formation. Later, for laminating, it may be reactivated with a heat source, such as an infrared light. Hence, the adhesive may be applied sufficiently in advance of channel formation, such as 1-10 minutes (for example) before, to facilitate channel formation.

### Connecting to Filled Channels (FIGS. 4M,N,O,P,Q)

FIG. 4G illustrates an example of an inlay substrate having a recess 416 for receiving a chip module 410 (dashed lines), and a channel (or channel pattern) 440 formed in the top surface of the inlay substrate 408 for filling with a flowable, conductive material (not shown, see FIG. 4H). The recess 416 may be rectangular, for receiving a leadframe-type chip module.

The channel (groove, trench, channel pattern) 440 (compare 462) may be formed in the inlay substrate 408 prior to the chip module 410 being mounted in the recess 416 (and prior to filling the channel with conductive material), using any of the techniques disclosed in FIGS. 4A-4D, or the like. An inlay substrate 408 with a channel 440 may be considered to be an “interim product”. The channel 440 may be filled with a conductive material, and may be in the substrate or in an adhesive layer, as discussed above.

The channel 440 may comprise a first portion extending at one location across the recess 416, and a second portion extending at another location across the recess 416. More particularly, for example,
a first channel segment 440a extends from a top portion of the recess 416 in one direction (towards the left, as viewed) across the surface of the substrate 408
a second channel segment 440b extends from the top portion of the recess 416 in another direction (towards the right, as viewed) across the surface of the substrate 408, and may be collinear with the first channel segment 440a
a third channel segment 440c extends from a bottom portion of the recess 416 in one direction (towards the left, as viewed) across the surface of the substrate 408
a fourth channel segment 440d extends from the top bottom of the recess 416 in another direction (towards the right, as viewed) across the surface of the substrate 408, and may be collinear with the third channel segment 440c.

It should be understood that the terminal 410a and 410b may be representative of contact areas rather than distinct terminals, on a top surface of a leadframe of the chip module 410.

The channel segments 440a, 440b, 440c, 440d (the entire pattern 440) are filled with conductive material 420.

FIG. 4H is a cross-sectional view of the inlay substrate 408, showing:
the substrate 408
a “pocket” recess 416 extending into a top surface of the substrate 408. (Although the recess 416 is shown as a “straight” “pocket” type recess, for purposes of this embodiment, it is not particularly important whether the recess is “stepped” or “straight”, or whether it is “window” or “pocket”.)
a chip module 410 disposed in the recess 416
a terminal 410a (which is one of two terminals) disposed on a top surface of the chip module. (The terminal 410a may be representative of a contact area on a top surface of a leadframe of the chip module 410.)
a channel 440 formed in a top surface of the substrate
conductive material 460 disposed in the channel 440

FIG. 4H shows laying an elongate conductive jumper 470 (such as a short length of wire) across the recess 416, extending over a terminal 410a, and being bonded to the terminal 410a, using a thermode 118 (see FIG. 1A) for connecting the jumper 470 to the terminals 410a of the chip module 410 (or connection areas of the leadframe). This is an “exploded” view.

As best viewed in FIG. 4G, to accommodate the jumpers 470, the channels 440 may have enlarged regions “e” where they are adjacent the recess 416. For example, whereas the channel 440 may be 60 μm wide, in the area adjacent the recess, it may be 100 μm wide. In the regions “e” adjacent the recess 416, the channels can also be deeper.

FIG. 4I shows the “finished product”, with the jumper 470 bonded to the terminals of the chip module.

FIG. 4J illustrates a variation where elongate, conductive jumpers 472 (compare 470) are initially bonded to the terminals 410a of the chip module 410, before the chip module 410 is inserted into the recess 416.

In prior art printing techniques conductive ink is applied to the surface of the substrate. The techniques are “additive” in nature.

By first having channels, the conductive material is embedded in the substrate, and may be flush with the surface thereof. By not protruding therefrom, after subsequent lamination, the pattern of the antenna may not be evident in the final (or interim) product.

According to an embodiment of the invention, a method is provided for producing an array of transponder sites on an inlay sheet using laser ablation or mechanical milling to create channels (trenches, grooves) in a synthetic material, for the purpose of creating the contour pattern of an antenna with several turns, and this may be done in conjunction with forming a recess in the substrate for a radio frequency identification (RFID) chip or chip module. The contour of the antenna may be similar to a conventional wire embedded antenna, but without the wire actually being in the synthetic material, but rather a continuous trench with a depth approximating the thickness of a wire conductor.

Said continuous trench in the form of an antenna with several turns having a start and end position, near a recess to accept a chip or chip module, is first prepared. In the next step of the invention the continuous trench is filled with conductive glue, ink, silver paste, metallic powder/particles and/or nanotubes or nanowires which act as a conductor with electrical characteristics similar to a printed ink, etched or a copper wire conductor. In the next stage of the process, the trenched antenna is connected to a chip or chip module.

An alternative method to creating such filled-grooved antenna with channels forming a number of turns, is first to apply a coating of PUR adhesive onto a synthetic material and after the opening time creating such antenna contour by laser ablation or mechanically milling of the adhesive layer. Or applying ultrasonic energy to the adhesive, creating a continuous indent similar in depth to the channel created through laser ablation or mechanical milling. A lithography process using a mask and a light source can also be used to create such an antenna. After the channel is created, it is filled with ink, conductive glue, ink, silver paste and or metallic powder/particles. In the next step of the process the synthetic material with adhesive layer is laminated to another substrate (e.g. synthetic material or paper) under temperature and pressure.

An antenna may be formed in
a synthetic inlay substrate or
in an adhesive layer on the substrate
   by forming grooves (channels, trenches) in the substrate or adhesive by:
laser ablation
mechanical milling
ultrasonic energy
gouging
any suitable technique
   and filling the grooves with a conductive material such as:
conductive glue
ink
silver paste
metallic powder/particles
solder paste
any suitable material
   and, the chip module may be connected with the resulting antenna.

### Using a Transfer Substrate

In some situations, it may be advantageous not to apply a material on or form a structure on a given substrate such as an inlay substrate, but rather to apply or form the material or structure to a separate “transfer substrate”, then transfer the material or structure to the given substrate such as the inlay substrate.

An example is inlay substrates adhesively attached to passport cover material to produce an intermediate product used in the production of security documents such as electronic passports. The material for the inlay substrate may be Teslin™, a waterproof synthetic film, single-layer, uncoated with a thickness of 356 microns.

The cover layer may be laminated (joined) to the inlay substrate using a polyurethane hot melt adhesive, such as approximately 50-80 μm thick. Prior to the adhesive process, the inlay substrate may be pre-pressed to ensure that the antenna wire does not protrude over (extend above) the surface of the Teslin™ substrate, in other words, to ensure that the antenna wire is fully embedded in the inlay substrate.

Non-reactive adhesives based on polyamide are typically not used in electronic passports for security reasons, as it would be possible to de-laminate the material by applying heat. Instead, reactive adhesive, moisture curing hot melt adhesive based on polyurethane, is used. Many are available.

The adhesive can be characterized by a high initial tack and a long open time (several minutes) or a short setting time (several seconds). In the latter case, the adhesive has to be reactivated using infra red light before the cover layer is attached to the inlay, or hot laminated within a certain period (within 1 to 2 hours). The adhesive cures exclusively in the presence of moisture and gains its final strength after 3 to 7 days.

The adhesive may be applied to the cover layer (cover material) at approximately 150 degrees Celsius, putting down a layer of 50 to 80 microns (μm). The inlay is applied to the cover layer (cover material) in web or in sheet form, and is then laminated together using a roll press. Thereafter, the laminated inlay with the cover layer (cover material) is cut to size and stored in a stack for 3 to 7 days in a storage area having a regulated temperature and humidity.

A method is provided for coating a transfer substrate such as Teflon with an adhesive layer, reactivating the adhesive layer through the application of heat and transferring the smooth side of the adhesive layer to the cover material.

An exemplary and illustrative transfer technique is forming an adhesive layer on a transfer substrate such as Teflon, then transferring the adhesive layer to an inlay substrate rather than to the cover layer of a passport. The following steps may be performed.

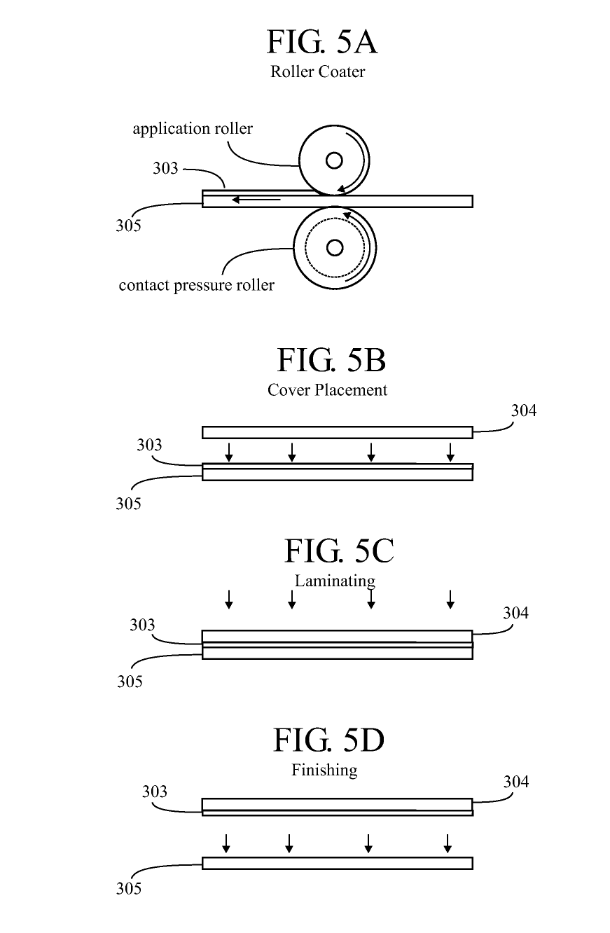

FIGS. 5A-5D illustrate a technique for smooth adhesive coating of and having a smooth adhesive finish on cover material, such as for an electronic passport, especially in the hinge area, to facilitate the adhesive attachment of the passport cover to the inlay. The material for the cover layer may be PVC coated offset board or acrylic coated cotton, embossed and thermo-resistant. In the case of the fabric material, the backside coating can be water-base coated (aqueous/non-solvent), synthetic coated or have no coating. The front side coating can have two base coatings and one top coating of acrylic. An alternative to acrylic coating is peroxylene-based coating (nitrocellulose). The fabric can have a strong bias (diagonal) in the weave (drill weave as opposed to linear weave) which gives it high tensile strength and restricts the elongation. The leather embossing grain can have the resemblance of the skin of a kid goat or sheep (skiver) and is applied using an embossing cylinder drum at a pressure of 60 tons at around 180 degrees Celsius (° C.). Because of the front and backside coatings, the fabric is not porous. The material for the cover layer may be a Holliston fabric.

In processing sheets, it may be necessary to use a roller coater system instead of a slot nozzle system (which is generally used in processing web material). The roller coater system basically applies the adhesive to the cover material via a rotating roller. A disadvantage of the roller coater system is that an impression (indent) is left on the adhesive layer from the roller, leaving a rough (irregular) surface texture. This may be particularly troublesome at the hinge area of an electronic cover inlay, having an uneven surface to attach the passport booklet to the inlay cover.

A smooth adhesive coating on the cover material may be realized by starting with a transfer substrate such as Teflon™, coating it with an adhesive layer, transferring the smooth side of the adhesive layer to the cover material and then later reactivating the adhesive layer through the application of heat and pressure. The smooth adhesive finish on the cover material, especially in the hinge area, may facilitate the adhesive attachment of the passport booklet to the inlay cover. Portions of the process may be applicable to other processes disclosed herein, and may be performed using the following steps.

FIG. 5A illustrates that a conventional roller coater system having an application roller and a contact pressure roller (silicone covered) can be used to coat a transfer substrate 505 having a very smooth surface, such as a sheet or continuous band of Teflon™ having a thickness of 0.230 mm, with an adhesive layer 503. The adhesive 503 (such as polyurethane reactive glue) may be applied to the transfer substrate with minimal pressure at a temperature of approximately 150° C. The top surface (as shown) of the transfer substrate 305 will thus be provided with a very smooth adhesive layer 503, of substantially constant thickness.

FIG. 5B illustrates that after applying the adhesive layer 503 to the transfer substrate 505, a layer of cover material 504 may be placed onto the adhesive-coated transfer substrate. FIG. 5C illustrates that next, at a belt lamination station, the adhesive 503 may be reactivated and become transferred to the cover material 504 by applying heat and pressure (arrows) to the “sandwich” of coated transfer substrate 503/505 and cover material 504. The pressure applied by the belt laminator to the sandwich may be approximately 2.5 Newtons. The reactivation temperature is approximately 160° C. The adhesive solidifies, non sticky, after the opening time of several seconds. FIG. 5D illustrates that in a final step, the cover material 504 (now with adhesive on it) is removed from the transfer substrate 505, with the adhesive layer 503 being transferred to the inner surface of the cover material 504. The resulting cover material (or layer, or simply “cover”), thus prepared with a substantially uniform adhesive layer 503, may later be laminated to an inlay.

U.S. Pat. No. 6,908,786 discloses a manufacturing process for a contactless smart card (or ticket) which includes the following steps: a manufacturing process for an antenna consisting in screen-printing turns of an electrically conductive polymer ink onto a transfer paper sheet, and then subjecting said support to heat treatment in order to bake and polymerize said conductive ink, connection of a chip 14, provided with contacts, to the antenna 12, lamination consisting in making the transfer paper sheet integral with a layer of plastic material 16 which constitutes the support for the antenna, by hot press molding, in such a way that the screen-printed antenna and the chip are both embedded within the layer of plastic material, removal of the transfer paper sheet, and lamination of the card body onto the antenna support by welding at least one layer of plastic material (18, 20) by hot press molding on each side of the support.

### Laser Ablation of Polymers

The controlled removal of substrate material by intense light is called laser ablation, derived from the Latin word ablatum, or sometimes also referred to as Ablative Photo Decomposition (APD). The material removal occurs only if a certain threshold in light intensity is exceeded.

Laser Ablation of polymers was first reported almost simultaneously by Srinivasan and Mayne-Banton and Kawamura et al. in 1982.

Laser ablation of polymers can be performed under atmospheric conditions and at room temperature, making it a very attractive alternative to traditional micromachining of 3 dimensional structures using high speed mechanical milling.

Thermoplastic polymers (compound with a molecular structure) have a low thermal conductivity and extremely high UV absorption and so direct bond breaking without heat is possible using lasers emitting in the UV range 157-355 nm. This process is called cold ablation, predominantly a photochemical process, and for the ablation of most polymers, nanosecond UV lasers are well suited.

The nature of the interaction mechanisms between the laser beam and the polymer substrate depend on the parameters of the laser light energy and on the physical (microstructure) and chemical properties (the arrangement of atoms or molecules within a polymer) of the substrate.

The successive phases in the irradiation of a polymer substrate with intense nanosecond UV-pulses can be described roughly in the following diagrams:

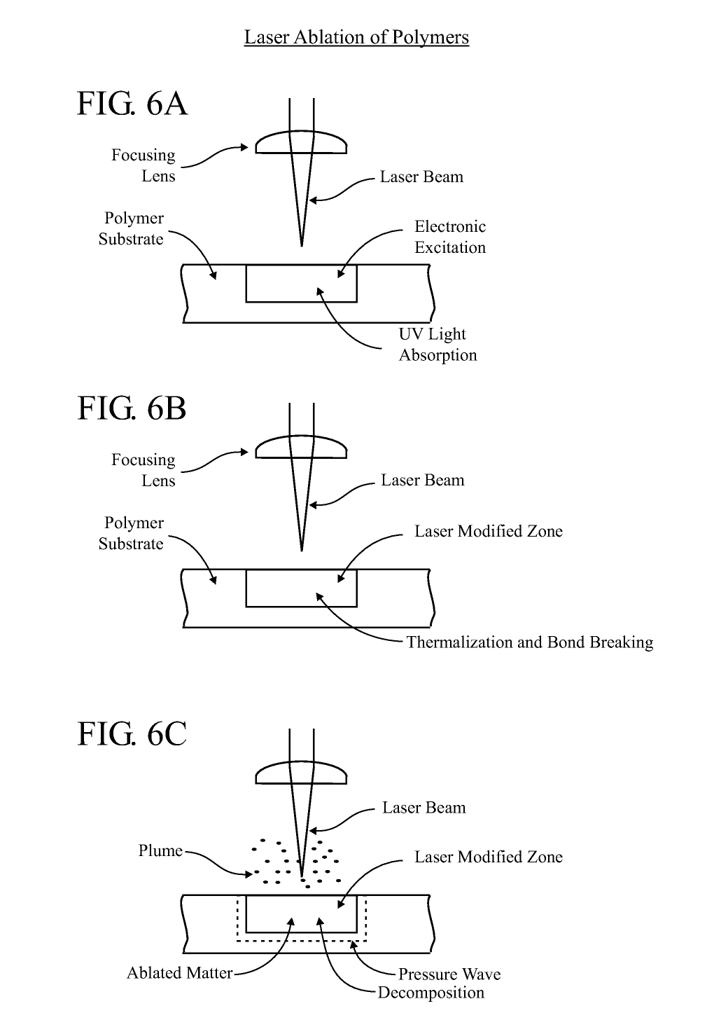

FIGS. 6A,6B,6C show a laser beam directed through a focusing lens onto a target (polymer) substrate. More particularly . . .

(a) stages of the laser ablation process. Interaction of the laser beam with the target substrate with UV light absorption and generation of electronic excitation
(b) high pressure generated by bond breakage of the target substrate.
(c) removal or sputtering of the ablated material from the target substrate.

The first phase of the laser ablation process begins with the absorption of photons at UV wavelengths in the substrate and this leads to electronic and vibrational excitation of the molecules.

In a second phase, the electronic excitation relaxes and a conversion decomposition mechanism takes place via heat generation (photothermal activation), photochemical and photomechanical reaction. This mechanism induces bond breaking, evaporation and desorption. However, the exact pathways leading to decomposition are unclear and controversial. See Bauerle, D. (2000). Laser Processing and Chemistry, third ed. Advanced Texts in Physics. Berlin, Heidelberg, New York: Springer-Verlag, incorporated by reference herein.

In a third phase, mainly gaseous components (a multiple of the original solid) will be forcefully ejected from the surface at high pressure, causing the removal of material. The components travel with speed and are preceded by a shockwave front due to compression of the ambient atmosphere.

The ejected plume consists of vapor, driving gas and particles of which some will be re-deposited as debris around the ablation crater. (The word crater is used in laser science to describe the process of ablation (explosive), the resulting area is a recess when machined properly at the right wavelength, pulse duration and fluence. A crater may be a recess, or a channel, or any feature formed by laser ablation.)

The deposition of debris can be minimized by directing a medium such as He or H2 to the ablation area at low pressure. These gases allow the plume to expand much faster preventing less particle formation and re-deposition.

Apart from the substrate material, the most important laser parameters affecting the ablation mechanism are:
Wavelength (λ) of the laser emission and the ability of the polymer substrate to absorb that wavelength
Pulse energy (E)
Intensity or irradiation fluence (φ) of the laser beam delivery
Pulse duration (t)
Frequency of the pulses (usually referred to as the repetition rate) (Q)
Angle of incidence
Beam shape and quality
Dwell time (irradiation time at a particular spot)

But, these parameters are further influenced by other factors such as multiphoton absorption, thermal diffusion, scattering due to surface roughness, and various hydrodynamical processes.

Laser ablation may be used for the machining of cavities in commercial polymers (ultra high molecular weight polyethylene and polycarbonate) to accept an electronic component such as a microchip (or chip module). Heretofore, UV laser ablation of commercial polymers in industrial applications have had limited commercial success because of high ablation thresholds, low ablation rates resulting in low production throughput and re-deposition of debris. According to an aspect of the invention, faster ablation may be achieved by amalgamating several techniques to create a hybrid ablation process.

It is a general object of the invention to structure polymer materials for hosting RFID chips (or chip modules) in manufacturing an intermediate product known as an inlay used by secure printers in the production of electronic passports and national identity cards. In particular, to machine a microporous polymer substrate (such as Teslin) with a target ablation rate of 5 mm³/second, creating a stepped recess or a pocket-type recess which extends only partially through a substrate. This recess or pocket is prepared to accept a leadframe RFID chip module such as an MOB 6 from the semiconductor company NXP.

An exemplary leadframe RFID chip module may comprise:
A leadframe (CuSn6) having a length of 8.1 mm±0.03, a width of 5.1 mm±0.03 and a depth or thickness of approximately 60 μm excluding plating (Ag) of 1.0 to 2.0 μm
A mould mass disposed over the chip and wire bonds, having a length of 5.1 mm±0.03, a width of 4.8 mm±0.03 and a depth or thickness of approximately 190 μm

The total thickness of the leadframe chip module may be approximately 260 μm, such as for an inlay substrate having a thickness of approximately 356 μm.

An exemplary recess in an inlay substrate
The total volume of organic material to be ablated is 7.185 mm³ based on a chip module (leadframe recess with dimensions of 8.2 mm×5.2 mm×0.06 mm with fillets of 1 mm at the corners and a mould mass cavity with dimensions of 5.2 mm×4.9 mm×0.190 mm and fillets at the edges of 1 mm) fitting perfectly into the recess pocket and sitting flushed with the surface of the material.
Generally, the chip module will be disposed in the stepped recess in the inlay substrate so as to be concealed therein. Alternatively, a pocket type recess with the approximate dimensions of 5.2 mm×4.9 mm×190 μm can be prepared to accept the mould mass of a leadframe chip module, with the leadframe protruding over the surface of the inlay substrate.

At a practical level, two types of recesses may be formed using laser ablation, a stepped recess and a pocket type recess and the goal is to minimize the ablation time and surface debris by using a hybrid ablation process. (FIG. 3B is an example of a pocket-type recess which is stepped.)

### Laser Cladding and Tool

A laser may be also used to facilitate filling grooves or trenches (whether made with laser ablation or other means) in a substrate or film with conductive material to form a conductor which may serve as the antenna of a transponder incorporated into the secure document.

A laser may be used to selectively modify conductive characteristics of a film such as an adhesive layer, in a controlled manner and in a prescribed pattern, to form a resistive (conductive) track in the film which may function as the antenna of a transponder module. This can be done in conjunction with laser ablation of channels wherein the conductive track may be disposed.

According to an embodiment of the invention, laser may be used to induce assembly of nanoparticles to produce a resistive (conductive) track for functioning as the antenna of a transponder.

Deposition of metallic nanoparticles into laser ablated channels in a polymer filled with a light absorbent medium via delivery into a high energy laser beam, fusing the nanoparticles in the medium to create an electrically resistive track (ERT) in the form of an antenna and connecting end portions of the antenna to a microchip to produce a transponder device.

The particles may initially be in powder form. The particles may be nanostructures such as nanoparticles, nanowires, nanotubes.

The substrate may be any non-conductive material, such as a polymer, such as Teslin™.

A flip chip module may be used to connect the die, and the antenna may be connected to the tracks (filled channels) on the flip chip module.

The light absorbent medium can be mixed with carbon (graphite) or ferrite powder to facilitate the electrical resistivity. The light absorbent medium may be a medium (material) which changes its chemical structure (atoms and molecules are excited) when subject to UV, VIS (Visible) or infrared light. The nanoparticles may be suspended in this medium (or matrix).

The deposition of metallic nanoparticles on a substrate layer and the simultaneous laser treatment can be used to create capacitor plates or electrodes between layers of synthetic or electrolytic material for the purpose of charging or discharging energy.

Using the abovementioned process, electrically conductive structures can be formed between several layers of synthetic (such as polymer) material, by inter-connecting tracks via openings or voids in given ones of the layers, to form a three dimensional component such as an antenna.

As an alternative to metallic nanoparticles (such as silver nanoparticles), metallic based inks (Ink is typically a powder mixed with a liquid.), nanowires or nanotubes can be used.

Any one or more of the chemical, optical, electrical, and magnetic properties of nanoparticles in a light absorbent medium may be modified to produce a conductive track, capacitor, inductor, micro battery cell or sensor. The light absorbent medium, such as a polymer, may react to UV light, and if the light energy is high enough to breakdown the carbon bonds there will be a chemical change.

Alternatively, the wire conductor (such as 110, FIG. 1A) can be substituted by metallic powder in the form of nano-particles which are trajected (ejected) or sprayed on in the direction of the trench or channel while at the same time, a laser is used to modify (such as melt) the particles to form a conductor in the polymer. This method is a form of laser cladding.

In order to pass over a conductive track which has been already laid, it is simply necessary to change the depth of laser ablation at the area where the wire tracks crossover, for example a deeper track passing under a shallower track (or vice versa, a shallow track passing over a deeper track). In other words, different tracks or portions of one track intersecting each other (in the x,y axes) but in different planes (z axis).

In contrast with laser ablation which may be viewed as a “subtractive” process, this forming and/or modifying of nano-particles into a resistive (conductive) track may be viewed as an “additive” process.

This is essentially a form of direct writing, but in the technique disclosed herein a medium is used for the conductive track which has optical and electrical characteristics. Generally, the nanoparticles improve the electrical (or electronic) characteristics of the medium or track, and perhaps also the magnetic characteristics. Optionally, the medium may be coated with a protective layer after laser treatment. If one were to melt the nanoparticles with the laser beam, this would leave just a molten material. In contrast thereto, by using the techniques disclosed herein a laser is used to change the characteristics of a medium by adding nanoparticles (carbon etc).

To assist the ablation process of the polymer in creating craters, trenches or channels, the ablation zone of the substrate material can be heated or frozen (e.g. using freeze gas) prior to the material being removed. Alternatively, the material can be treated with carbon by passing the polymer through a laser printer to induce (lay down a specific pattern or broader blanket of) black toner into the area to be machined. Alternatively, black ink can be applied to the substrate material prior to ablation. Carbon may have the beneficial effect of lowering the ablation threshold and increasing the absorption of the laser energy at the ablation zone. Reference is made to U.S. Pat. No. 4,693,778, incorporated by reference herein.

U.S. Pat. No. 6,152,348, incorporated by reference herein, discloses device for the application of joint material deposit. Device for the singled-out application of joining material deposits (30), particularly solder beads, from a joining material reservoir (11) with an application device (13) and a singling-out device (12) for singling-out joining material deposits from the joining material reservoir, wherein the singling-out device (12) is designed as a conveying device (20) for the singled-out transfer of joining material deposits (30) to the application device (13).

### Some Embodiments of Techniques for Forming Conductive Tracks in a Medium

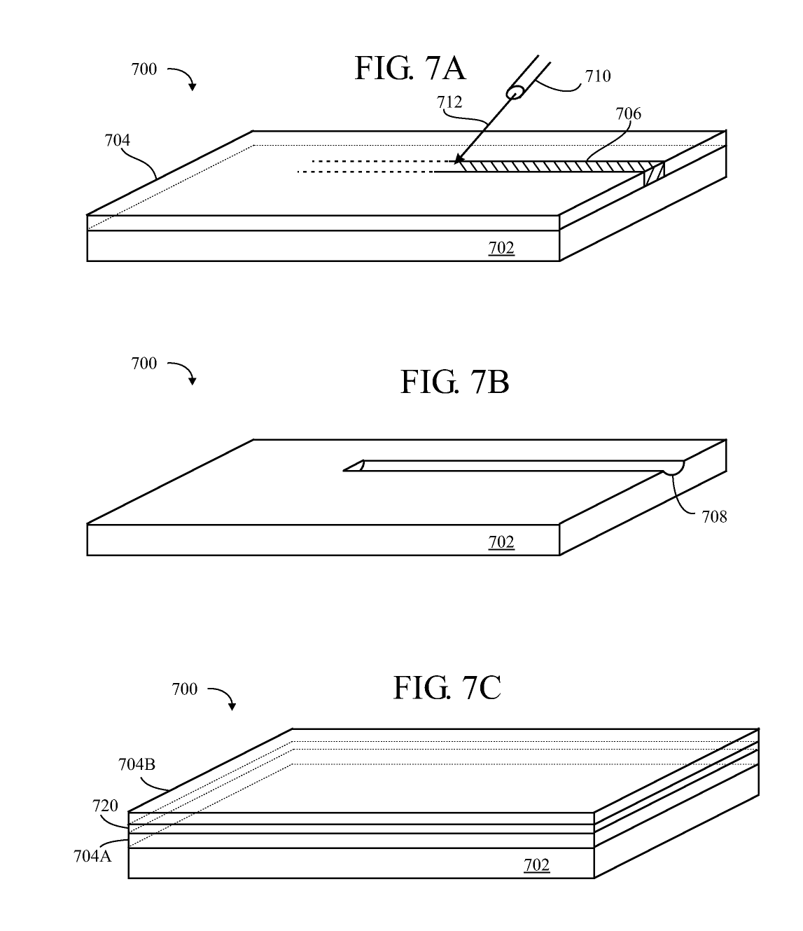

FIG. 7A illustrates technique 700 for forming conductive structures (microstructures), such as lines (tracks), in a substrate, such as (but not limited to) any of the inlay substrates described above.

The technique may be used to form the antenna of a transponder for a secure document such as an electronic passport, such as in (but not limited to) any of the embodiments described above.

A substrate 702 is provided. A layer or film of material 704 (or “medium”) is deposited over the substrate. A laser 710 is used to modify a selected portion of the film 704. The beam 722 from the laser 720 moves along the surface of the medium 704 to form a pattern 706, which may be a line, an area, or the like. For patterns which are areas rather than lines, several passes of the laser may be required.

The pattern 706 may be in the form of a elongated (narrow, lone) line, substituting for the wire which is traditionally used in a transponder, and may pass over the terminals of a chip module (not shown) which is previously installed in a recess (not shown) in the substrate 702. (See, e.g., FIG. 1B showing a chip module installed in a recess in a substrate.)

FIG. 7B shows that the substrate 702 may first be prepared with a channel 708, such as a laser-ablated channel as has been described hereinabove.

Then, the layer 704 of material may be applied, and the laser used to modify the material, creating the resistive (conductive track) coincident with (aligned with) the channel 708.

This technique of modifying a material to create a resistive (conductive) track is different than the techniques described above for filling channels formed in a substrate or film. In the “filling” techniques, a quantity of flowable, conductive material may be applied on the surface of the substrate. Some of the conductive material may be in the channel. The conductive material may be viscous, such as metallic powder or conductive glue. A squeegee (noun) may be used to fill the channel with conductive material and squeegee (verb) away the excess conductive material. Exemplary (non-limiting) dimensions for the channel may be 60-80 μm deep, and having a width of, for example, 50-100 μm. In the adhesive layer filling, the adhesive may be 80 μm thick glue. The channel (groove, trench) may be, for example, 60-80 μm deep. The channel may go all the way through the adhesive, and further into the substrate 608.

The technique of modifying a medium such as an adhesive layer to have conductive tracks may be combined with laser ablation of channels, and may also be combined with the filling techniques described hereinabove.

The channel 706 is representative of a channel or recess having any desired length and width, and being arranged in any desired pattern, such as for the turns of an antenna for a transponder, such as has been described above. For example, channel may be 60-80 μm deep, and having a width of, for example, 50-100 μm, and may have a overall length of approximately 1 meter.

Rather than being “elongated”, such as for the “wire” of a transponder, the channel 706 may be a more of a rectangular area, such as for a plate of a capacitor, an electrode of a battery or a shielding layer of ferrite.

According to an embodiment of the invention, rather than filling the channel with conductive material and squeegeeing away the excess, the surface of the substrate 702 is covered with a viscous material 704 (such as a viscous liquid) containing nanoparticles of a conductive material and a laser 710 is used to congeal (to cause to solidify or coagulate or to undergo a process likened to solidification or coagulation) the nanoparticles according to a desired pattern. The pattern “written” by the laser 710 may coincide with the pattern of the channel 708, but may also extend beyond the channel onto an “un-channeled” portion of the substrate 702.

The material 704 may be a conductive glue (a mixture in a liquid or semi-liquid state that adheres or bonds items together) which can be modified (such as polarized) by laser irradiation, allowing for increased conductivity. For example, the material (1504) may be a quantum tunnelling composite (QTC).
Quantum tunnelling composites (or QTCs) are composite materials of metals and non-conducting elastomeric binder, used as pressure sensors. They utilize quantum tunnelling: without pressure, the conductive elements are too far apart to conduct electricity; when pressure is applied, they move closer and electrons can tunnel through the insulator. The effect is far more pronounced than would be expected from classical (non-quantum) effects alone, as classical electrical resistance is linear (proportional to distance), while quantum tunnelling is exponential with decreasing distance, allowing the resistance to change by a factor of up to 10e12 between pressured (pressurized) and unpressured (un-pressurized) states.

Another example for the material 704 may be an intrinsically conductive polymer (ICP).
Conductive polymers or more precisely intrinsically conducting polymers (ICPs) are organic polymers that conduct electricity. Such compounds may be true metallic conductors or semiconductors. The biggest advantage of conductive polymers is their processability. Conductive polymers are also plastics (which are organic polymers) and therefore can combine the mechanical properties (flexibility, toughness, malleability, elasticity, etc.) of plastics with high electrical conductivities. Their properties can be fine-tuned using the methods of organic synthesis.

The laser 710 may be a UV laser, pulsed or CW (continuous wave), may be modulated, may be two or more lasers, using any suitable parameters to achieve the desired result including, but not limited to, any of the laser operating parameters set forth herein.

The laser 710 may be a nanosecond, picosecond or femtosecond laser operating in the UV, VIS or IR spectrum or may be a CO₂ laser operating at extreme infrared. The polymer may be porous facilitating the ablation process because of the reflection or absorption of the laser beam within the confined space of these pores.

### Two Layers

FIG. 7C shows an embodiment where a first layer 704A (compare 704) is on a substrate 702. An insulating layer (or film) 720 is disposed over the first layer of material 704, and a second layer of material 704B is disposed over the insulating layer 720. Then, a laser 710 may be used to modify the properties of the two layers 704A and 704B to be resistive (conductive), thereby forming a capacitor, or the like. The laser may modify both layers 704A and 704B at once (simultaneously), or first the layer 704A may be modified, followed by application of the insulating separating layer 720, followed by the laser modifying the second layer 704B.

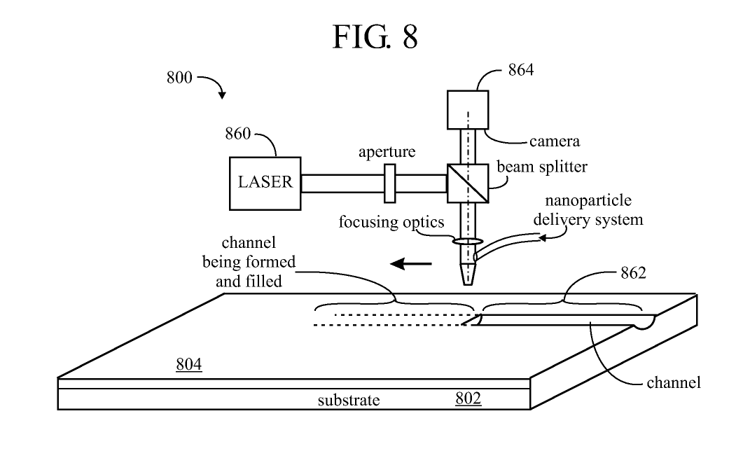

FIG. 8 illustrates an exemplary tool, system and technique 800 for forming and filling channels in a polymer substrate 802, or a layer (medium) 804 on the substrate 802 to form conductive tracks, such as for the antenna of a transponder. A laser 860 emits a beam for laser ablating a channel 862 in the substrate. In conjunction with this, a nano-particle delivery system 870 delivers nanoparticles which are modified by the laser and fill the channel. A camera 864 and beam splitter 866 may be included, as shown, to monitor the process. Spraying nanowires is also a possibility, but a preferred method may be a form of inkjet (propulsion) or sputtering to achieve accurate line width for the conductive tracks.

### Printing and Nanoparticles

The printing of conductive inks consisting of dispersed metal nanoparticles in a liquid medium onto low temperature substrates is gaining attention in the radio frequency identification (RFID) industry, especially in the manufacture of passive ultra high frequency (UHF) tags for item-level tracking of consumer goods, an electronic replacement for the ubiquitous barcode.

Application of this technology includes patterning of antenna structures on paper and synthetic films, generating bumps on flip chips and creating traces or lines for interconnection straps and jumpers.

The nanometal particles or powders in liquid synthesizing conductive ink are gold, silver and copper. Cu particles are difficult to fabricate since they oxidate or aggregate easily. The ink contains dispersants to prevent nanoparticle aggregation and modifiers to control viscosity and surface tension. The size of the particles range from 2 nm to 50 nm, and the lowest temperature of annealing to make the particles sufficiently conductive is determined by how easily the carrier fluid can be removed.

Printing on flexible substrates such as polycarbonate with a low temperature softening point below 150° C. is a challenge, limiting the sintering process temperature of the nanoparticles. However, polymeric films with a high glass transition temperature, such as polyimide, allow a sintering temperature of 240° C. which greatly improves the resistivity of the conductor traces.

Sintering a method for making objects from powder, by heating the material in a sintering furnace below its melting point (solid state sintering) until its particles adhere to each other. Sintering is traditionally used for manufacturing ceramic objects, and has also found uses in such fields as powder metallurgy.

To increase the thickness of the metal traces or lines for antennas targeted for high frequency transponders operating at 13.56 MHz, the printing and sintering process can be repeated several times to obtain a low enough series resistance. Alternatively, an electroless plating process can supplement the printing of the nanoparticle seed layer to realize a lower resistance. Some of the obstacles to overcome in manufacturing conductive antennas and traces on substrates are processing inks with metal nanoparticles of specific size, depositing high resolution patterns, heating and fusing the nanoparticles into a metallic conductor without damaging the underlying substrate, preventing oxidation pre and post heat treatment, achieving acceptable conductivity and having strong mechanical adhesion of the metallic conductor with the substrate.

### Metallization by Laser Sintering

The laser-based curing of printed nanoparticle ink to fabricate low resistance conductors on sensitive polymeric substrates and interconnections on semiconductor devices is a need-driven trend in the RFID industry.

Pulsed laser based curing of printed (Drop on Demand) gold nanoparticle ink combined with controlled substrate heating has been investigated and shown to produce highly conductive microstructures without damaging the polymeric substrate. Post laser treatment has been used to define small features on the pre-printed substrate by ablation. Investigations have also shown that the microstructures as well as electrical and mechanical properties are affected by the laser power and the laser scanning velocity.

Other experimental works have reported that the physical morphology of laser annealed silver based ink using a DPSS laser was determined by a number of parameters including laser fluence, the spot size of the focused laser output, working speed of the galvo mirrors and the repetition rate of the laser firing. It was found that a laser wavelength which is more weakly absorbed by the nanoparticles could produce a more stable and homogeneous curing condition.

Currently, photonic curing is being developed to fuse nano-scale metallic ink particles into conductive traces on low-temperature substrates by exposing them to a brief, intense pulse of light from a xenon flash lamp, as described in U.S. Pat. No. 7,820,097 ('097 patent).

For interconnection purposes, high speed drop on demand laser plating on a Cu leadframe using Ag nanoparticles to form wire-bonding pads have been investigated, confirming that the quality of the sintered Ag pad and wire bondability are almost the same as those of an electroplated Ag film.

A novel flip-chip bonding technique with laser assist to connect semiconductor devices to piezoelectric substrates using 50 μm diameter Ag paste bumps has been reported, using the laser to locally cure the paste bump.

### Providing Enlarged Contact Areas on a Substrate

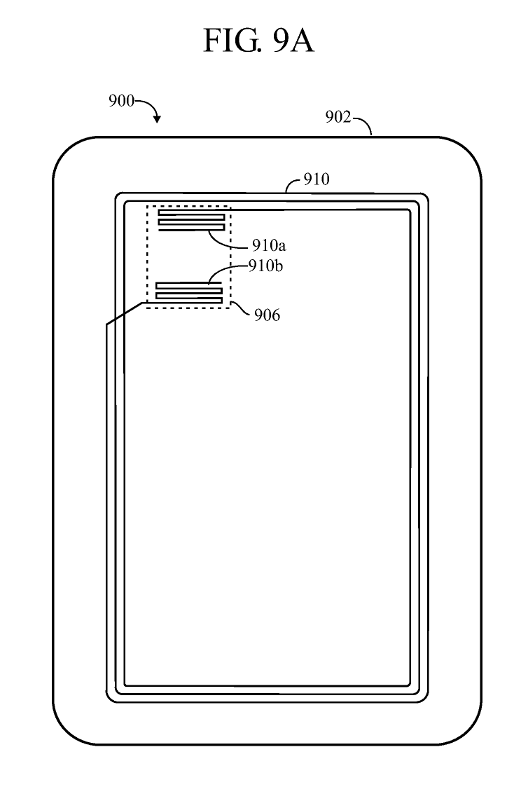

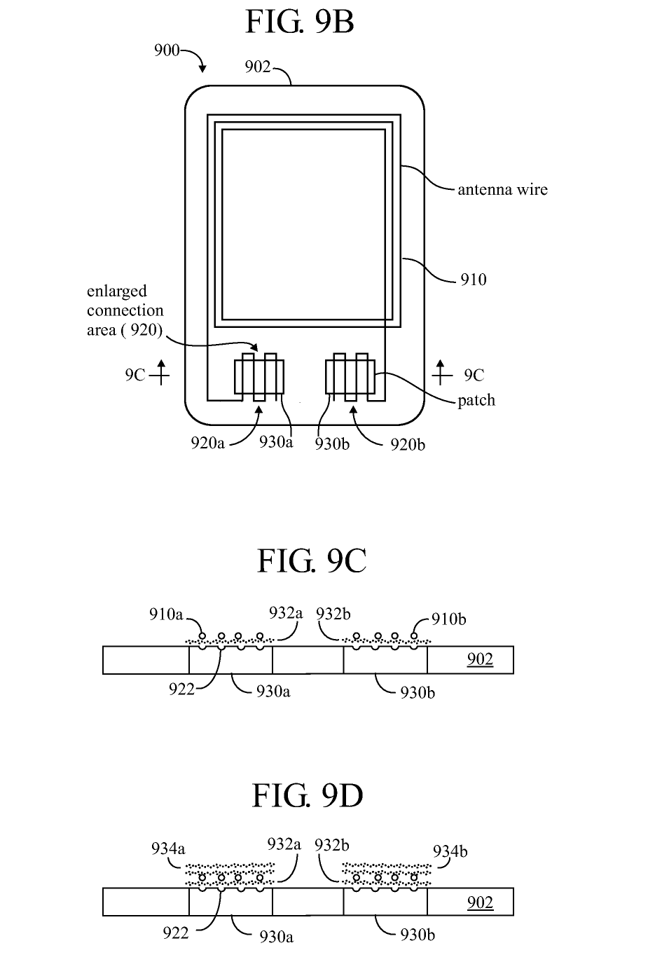

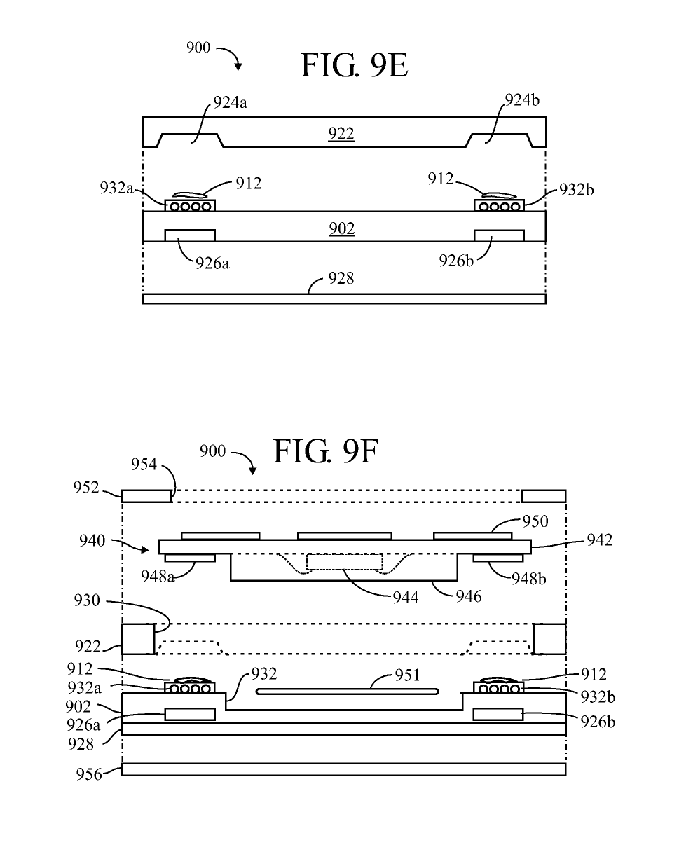

FIG. 9A illustrates an inlay substrate 902 for a dual interface inlay 900. The inlay 900 may comprise additional sheets (not shown) laminated to the inlay substrate, and may be in credit card format. The substrate 902 may be of a synthetic material, such as PVC or PC, and may have a thickness of approximately 250 μm (microns). A comparable DIF inlay may be found in and U.S. Pat. No. 7,980,477 (see FIG. 2A therein)

An antenna wire 910 may be mounted to a surface of the substrate 902 such as by ultrasonic embedding (countersinking) of the antenna wire at least partially into the surface of the substrate. A flat coil pattern for a HF antenna, comprising an appropriate number of turns may be formed in this manner.

End portions 910a and 910b of the antenna wire 910 may be formed with squiggles or meanders to provide an area of increased surface area for subsequent attachment of a chip (or chip module) to the antenna 910. These squiggles or meanders may be considered to be “contact areas”, and are generally located on opposite sides of a transponder site 906 on the surface of the bottom sheet 902 where a chip or chip module (240, FIG. 2C of the '477 patent) will be mounted. The transponder site 906 need not be, and generally is not a recess. Rather, the transponder site 906, shown in dashed lines, is merely a defined location on the substrate 902. The antenna wire 910 may be insulated wire, and insulation from the end portions 910a and 910b of the wire may be removed, such as through laser treatment.

According to an embodiment of the invention, enlarged connection areas may comprise a conductive layer such as nanoparticles which may be fused with the end portions of the antenna wire. The end portions of the antenna wire may be formed with meanders in the enlarged connection areas. In the enlarged connection areas, patches of different substrate material having different glass transition temperatures and embedding qualities may be inserted into the substrate to withstand the processes (temperatures) of nanoparticle deposition and sintering. For example, patches of Teslin™ may be inserted into a PC substrate which has been punched out to accept the Teslin™ patches. Teslin™ has a higher melting point than PC, but it is more difficult to embed wire in Teslin™ than in PC. Channels may be formed, such as by laser ablation, in the substrate for receiving the antenna wire, particularly in the patches which will receive the end portions of the antenna wire.

FIG. 9B illustrates an inlay substrate 902 for a dual interface inlay 900. The inlay 900 may comprise additional sheets (not shown) laminated to the inlay substrate, and may be in credit card format. The substrate 902 may be of a synthetic material, such as PVC or PC, and may have a thickness of approximately 250 μm (microns).

Channels may be formed in the surface of the substrate, in the pattern of the antenna. Bare, insulated or self-bonding wire 910 may be laid in the channel, such as using an ultrasonic tool (sonotrode and capillary).

End portions 910a and 910b of the antenna wire 910 may be formed with squiggles or meanders to provide an area of increased surface area for subsequent attachment of a chip (or chip module) to the antenna 910. These squiggles or meanders define (or may be considered to be “enlarged contact areas” 920a and 920b. The two enlarged contact areas 920a and 920b are spaced a distance apart from one another, and may generally correspond to the location of corresponding two terminal areas on a chip or chip module. The enlarged contact areas 920a and 920b will generally be larger than the chip (or chip module) terminals, and may serve as a type of interposer.

Interposer An interposer is an electrical interface routing between one socket or connection to another. The purpose of an interposer is to spread a connection to a wider pitch or to reroute a connection to a different connection.

The substrate 902 may be punched out to have openings at the location of the enlarged contact areas 920a and 920b, and patches 930a and 930b of another material may be inserted into the openings. Alternatively, a single large opening may be provided with a single large patch constituting the two contact areas. The patches may be Teslin™. The inlay substrate may be PC.

The patch substrate can also be of the same material as the inlay substrate. One aspect of the invention is that the patch may be processed in a special coating machine, inkjet printer or sputter unit (under vacuum). And, it can be heated or cooled to perform an operation.

FIGS. 9C and 9D illustrate that channels 922 for accepting the end portions (meanders) of the antenna wire may be formed in the patches. As best viewed in FIG. 9A, these channels (and meanders) may extend slightly beyond the patches, into the substrate.

The patches may be coated with a layer (or coating) of conductive nanoparticles. As best viewed in FIG. 9C, a portion 932a of the layer of nanoparticles may be deposited on the patch 930a and another portion 932b of the layer of nanoparticles may be deposited on the patch 930b. The layer will be very thin (on the order of a few tens of nanometers), and may conform to the contour of the channels. Many layers may be deposited. The substrate can be preheated before coating.

When the end portions 910a and 910b of the antenna wire are embedded in the patches, such as using ultrasonics, a connection is made to the enlarged connection area portions 932a and 932b of the nanoparticle layer(s). The wire conductor penetrates the nanoparticle coated substrate. Insulation (if any) should be removed from the end portions of the antenna wire, such as by laser ablation, to enhance the connection. To cause a diffusion process during embedding, the channel may be coated with non-sintered particles.

Ultrasonic embedding of the antenna wire (ultrasonic is generally not required for laying the wire in the channel) may improve contact between the end portions of the wire and the enlarged connection areas within which they are embedded.

Alternatively, the nanoparticles may be deposited after the wire is laid in the channel to create the enlarged connection areas.

After laying the wire, additional further coating(s) 934a and 934b of the two enlarged contact areas may be performed, such as with nanoparticles to sinter with or fuse with the wire conductor. See FIG. 9D. Alternatively, electroless plating may be used to increase the thickness of the enlarged conductive areas.

The wire may be copper. The nanoparticles may be gold or silver particles suspended in a liquid such as alcohol/ethanol. A laser may be used to fuse (or sinter) the particles. Generally, according to the quantum confinement effect, the small nanoparticles will attract each other and come together, at a temperature lower than the melting temperature for bulk or ordinary (macro) particles.

The connecting of the enlarged connection area (and connection portions of the antenna wire) to terminals of the chip module may be effected in a manner similar to U.S. Pat. No. 4,980,477 (S11B), for example, with a conductive material (solder balls or flexible solder paste, or conductive glue).

FIG. 9E illustrates a dual interface inlay 900. The inlay 900 may comprise various laminated sheets, and may be in credit card format. An antenna wire 910 is “mounted” to a top (as viewed) surface of a bottom sheet (substrate) 902. End portions 910a and 910b of the antenna wire 910 are formed with squiggles or meanders to provide an area of increased surface area for subsequent attachment of a chip (or chip module) to the antenna 910. Nanoparticles may be incorporated into the process, to provide the enlarged contact areas 932a and 932b, as described above (represented as rectangles).

FIG. 9F illustrates a cross section of the dual interface inlay 900. A top sheet 922 is positioned over the bottom sheet 902, and will be laminated thereto.

The antenna wire 910 and squiggle end portions 910a and 910b of the antenna wire 910 are visible on the top (as viewed) surface of the bottom sheet 902. A dollop of conductive material 912 is applied to at least a portion of the top surfaces of the squiggles 910a and 910b. For example, solder balls or flexible solder paste, or conductive glue is applied to the enlarged connection areas 932a and 932b. A cavity 930 may be milled, extending through the top sheet 922 to (i) allow a chip module 940 to be mounted through the top sheet 922 onto the bottom sheet 902, and (ii) to expose the enlarged connection areas 932a and 932b.

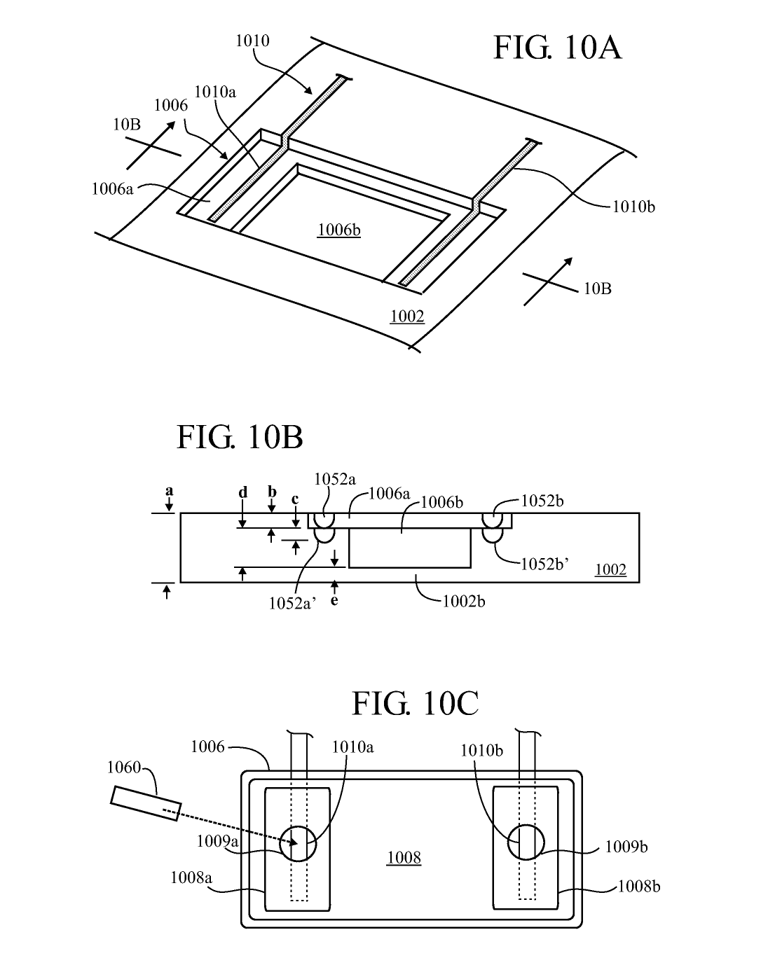

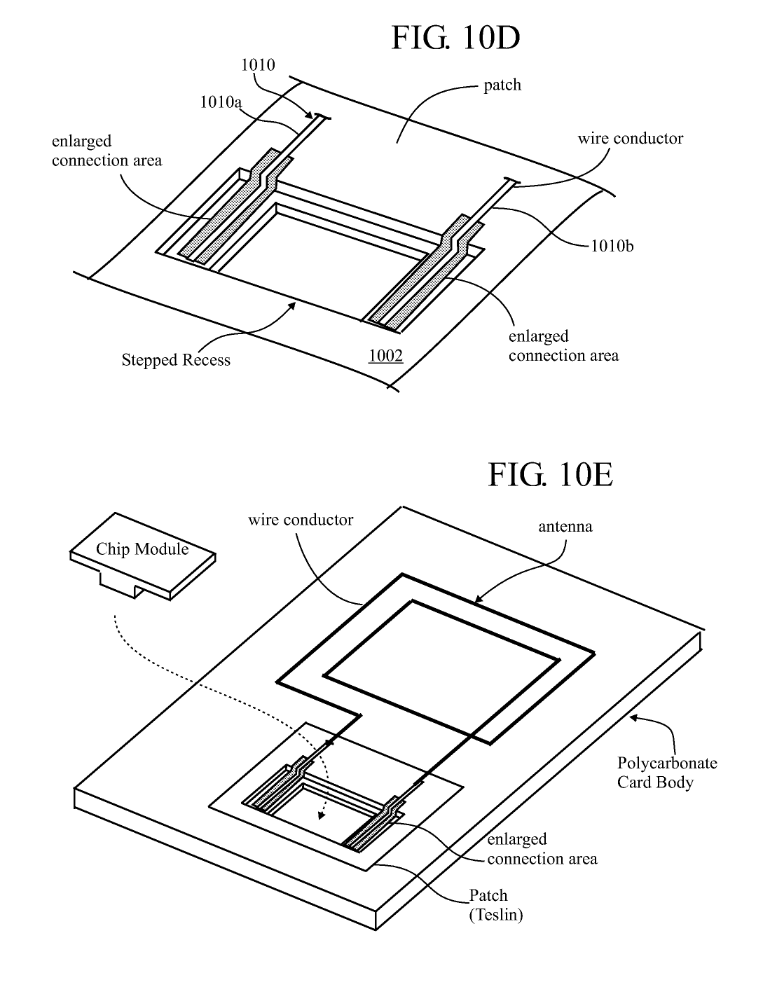

Enlarged Connection Areas within the Recess FIGS. 10A-10C illustrate a technique 1000 for mounting and connecting an antenna wire. A stepped recess 1006 for a chip module 1008 is formed in a substrate 1002 and has an upper portion 1006a and a lower portion 1006b. The recess 1006 may be formed by laser ablation. In conjunction with forming the recess 1006, a channel (1052) for accepting the antenna wire (1010) is formed.

A first portion 1052a of the channel (1052) extends into the surface of the substrate 1002, and continues (as an “extension” 1052a′ of the portion 1052a) into the surface of the lower portion 1006b of the recess 1006. A second portion 1052b of the channel (1052) extends into the surface of the substrate 1002, and continues (as an “extension” 1052b′ of the portion 1052b) into the surface of the lower portion 1006b of the recess 1006.

When the wire (1010) is laid into the channel (1052), a first end portion 1010a of the wire is laid into the extension 1052a′ of the first portion 1052a of the channel, and a second end portion 1010b of the wire is laid into the extension 1052b′ of the second 1052b of the channel. (The wire is omitted from the view of FIG. 10B, for illustrative clarity.)

The channel and recess may be formed sequentially. For example, first form the channel for accepting the antenna wire in the surface of the substrate, then after laying down the wire in the antenna channel (104 cm), the stepped recess is created in the polymer substrate to accept the chip module. During forming the recess, the end portions of the wire are “the way” and the self bonding layer and insulation layer will be removed from the wire at the positions where the end portions of the antenna wire will exposed to the terminal areas of the chip module. Then the chip module may be installed in the recess and connected with the end portions of the antenna wire.

Alternatively, as illustrated, the channels and recess are fully formed before the antenna wire is laid into the channels.

Another alternative may be to connect the end portions of the antenna wire to the terminal areas of the chip module prior to installing the chip module into the recess. (The chip module would be supported immediately above the recess during connecting the wire to the terminals and laying the wire into the antenna channel.)

FIG. 10C shows that after the wire is laid into the channel, the chip module 1008 may be installed into the recess 706, with the mold mass down. The orientation is with the mold mass down, and the end portions of the wire to be connected to the leadframe are on the mold mass (down) side of the leadframe.

The wire may be self-bonding wire. In the process of forming the recess and channel, and laying the wire, additionally insulation (the self bonding layer and insulation layer) may be removed from the top (exposed) surface of the end portions of the wire to facilitate connecting to terminal areas of the leadframe.

Two terminal areas 1008a and 1008b are illustrated. These are essentially portions of the leadframe. A hole 1009a is created through the terminal area 1008a to expose a portion of the underlying end portion 1010a of the wire. A hole 1009b is created through the terminal area 1008b to expose a portion of the underlying end portion 1010b of the wire. The end portions 1010a and 1010b may be connected in any suitable manner to the corresponding terminal areas 1008a and 1008b of the leadframe (of the chip module 1008). For example, by soldering. Or, a beam from a laser 1060 can be directed through the holes 1009a and 1009b in the respective terminal areas 1008a and 1008b to effect the connection (laser welding) of end portions 1010a and 1010b to terminal areas 1008a and 1008b.

The holes 1009a and may be micro holes which are percussion drilled into the metal leadframe of the chip module at each terminal area. This allows for the welding, soldering or crimping of the leadframe terminals to the respective end portions of the antenna wire. For the interconnection per welding, the laser beam is directed into the hole, causing the copper wire to reach its melting point in a matter of nanoseconds (ns), picoseconds (ps) or femtoseconds (fs). The chip module with the micro holes may be placed over the wires for interconnection.

Some exemplary dimensions are:
overall thickness “a” of the substrate 1002, approximately 356 μm
depth of an upper portion 1052a of the channel 1052 extending into the top surface of the substrate 1002, approximately 100 μm
depth “b” of an upper portion 1006a of the recess 1006 which accepts the leadframe, approximately 80-100 μm
depth “c” of portion 1052b of the channel 1052 in the bottom of the upper portion 1006a of the recess 1006, approximately 100 μm to accommodate a wire have a diameter of approximately 80 μm
depth “d” of a lower portion 1006b of the recess 1006 which accommodates the mold mass of the chip module, approximately 180 μm (from the bottom of the upper portion 1006a)
a remaining thickness “e” of the substrate 1002 under the lower portion 1006b of the recess, approximately 100 μm.
the total thickness “a” equals the depth “b” of the upper portion 1006a plus the depth “d” of the lower portion 1006b plus the thickness “e” of the remaining portion 1002b of the substrate under the lower portion 1006b.

FIGS. 10D and 10E illustrate an embodiment of a national ID card comprising a patch such as of TeslinTM disposed in a PC card body, for the reasons stated above (such as higher melting temperature). In any of the embodiments disclosed herein involving a patch, the patch may be omitted and the remainder of the processes (channel, nanoparticle deposition and sintering, laying the wire, etc.) may be performed on the inlay substrate itself.

In contrast with the two separate patches shown in FIGS. 9C and 9D, the patch shown in FIGS. 10D and 10E is a single patch which is large enough to encompass two enlarged connection areas.

A stepped recess for a chip module may be formed in the patch, and channel (or channels) for accepting the antenna wire may extend into a recess for the chip module, as described above with respect to FIGS. 10A, 10B.

Prior to laying the antenna wire in the channel (1052), conductive nanoparticles may be deposited (or coated) onto selected portions of the surface of the patch, such as
on the surface of the lower portion of the recess, in and around the extensions 1052a′ and 1052b′ of the first and second portions 1052a and 1052b of the channel. This results in two enlarged connection areas for making contact with respective two terminal areas of the chip module,
the deposition of nanoparticles may extend up and over the edge of the recess onto the surface of the patch substrate, adjacent the recess.

Alternatively, the antenna may not be connected to the substrate itself, but rather use the metalized layer (additive process: deposited or coated or subtractive process: etched) as a capacitor plate as part of an inductive coupling system.

### Another Embodiment

Some embodiments of the invention relate to laser ablation of channels and recesses (pockets), and the coating thereof said to create a conductive layer. It should be understood that instead of nanoparticle coated substrates, it is also possible to use electroless deposition process to create a metallized substrate. The interconnection process can be per laser diffusions of the nanoparticles with the wire conductor.

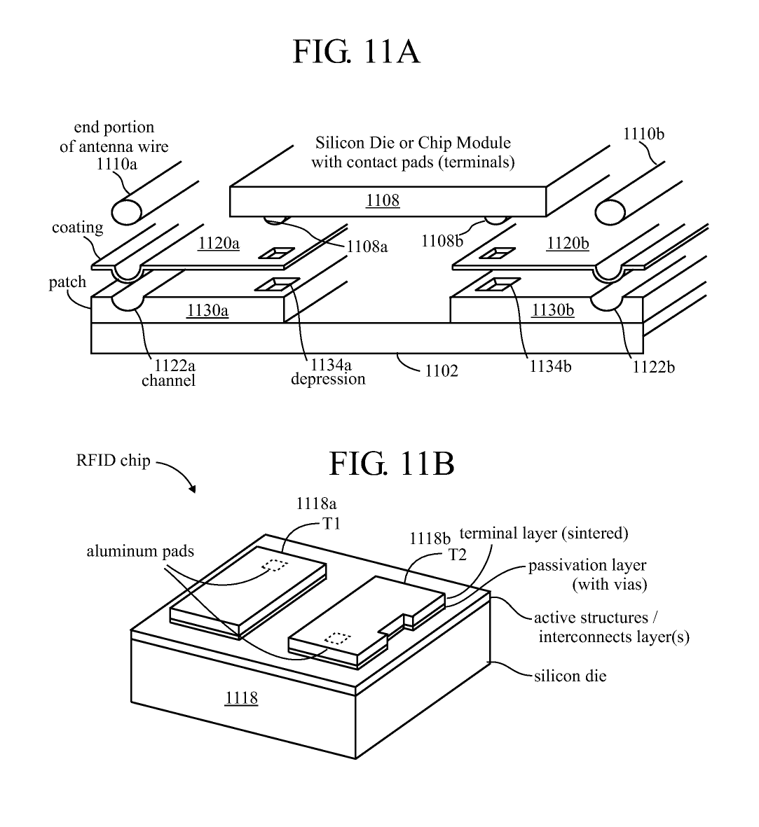

FIG. 11A shows a relevant portion of a transponder comprising an inlay substrate 1102 which may have a distinct support layer (not shown) on its top surface. Two enlarged connection areas 1120a and 1120b are formed on the inlay substrate by coating the areas with conductive material such as nanostructures (e.g., nanoparticles). Prior to (or after, or both prior to and after) coating, laser ablated channels 1122a and 1122b may be formed in the inlay substrate for accepting end portions (connection portions) of the antenna wire. As illustrated, the connection areas (coatings) 1120a/b are formed on separate patches 1130a and 1130b, which may be in the manner of the patches 930a/b (FIG. 9C), and the channels 1122a/b would be formed in the patches 1130a/b.

End portions 1110a and 1110b of an antenna wire (1110, compare 110) may be laid in the channels 1122a and 1122b, respectively. The end portions of the antenna wire may be connected to the connection areas using nanoparticles in the manner shown in and described with respect to FIGS. 9C and 9C.

A silicon die or chip module 1108 having contact bumps 1108a and 1108b extending from a bottom (as viewed) surface thereof is shown positioned to be mounted on the substrate 1102. Detents (depressions) 1124a and 1124b may be formed in the inlay substrate, more particularly in the connection areas 1130a/b corresponding to the location and size of the contact pads (bumps, enlarged pads) on the bottom of the silicon die, for receiving same. These may also be coated with the nanoparticles.

Generally, the two channels 1122a/b for receiving the end portions 1110a/b of the antenna wire in the enlarged connection areas will be spaced farther apart than the two depressions 1124a/b for receiving the two terminals 1108a/b of the chip module 1108.

### Enlarged Terminal Areas

Reference is made to U.S. Pat. No. 5,281,855, which may be incorporated by reference herein.

FIG. 11B illustrates a chip 1118 prepared with enlarged terminal areas 1118a (T1) and 1118b (T2). The chip may be 1 square mm having a pad size 80 μm×80 μm, aluminum. Bumps may be grown on the pads to an exemplary height (thickness) of 25 μm. A layer of passivation may be provided, with an openings (two). A terminal layer may be grown, through sputtering, and may extend over the passivation, as shown. Nanoparticles on the passivation may be sintered to create an enlarged connection area (“terminal area”).

The resulting chip with enlarged connection areas may be “flipped” (terminals down) onto an inlay substrate or into a card body for connection with an antenna or enlarged connection areas associated with an antenna, such as disclosed herein, or onto an ink (printed antenna), or the like.

### Additional Features, Advantages, Etc.

An underlying layer in the stack-up of a card body could include a ferrite polymer layer which can be hot laminated with the other layers.

A carrier for a chip or chip module may be etched to form a small antenna with many turns, inductively coupled with a “normal” larger antenna with a few turns on the substrate.

Microcracking results from the micro-movement of the chip module in the card body. By placing or installing the chip module into a patch material (separate from the inlay or antenna substrate) such as Polyurethane film, Teslin film etc, and then placing said patch into or onto an inlay substrate such as polycarbonate, you then have a soft body holding the chip module within the hard shell of the card body. This may reduce microcracking and improve reliability.

Antenna wire (such as self-bonding or insulated copper wire) may be prepared by removing the insulation (or self-bonding coating) and coating the naked (bare) wire with a layer of nanoparticles such as gold or silver to prevent oxidation thereof. This may be done for at selected portions of the wire, such as where it will be embedded into enlarged connection areas also formed with nanoparticles, for example.

### Shielding

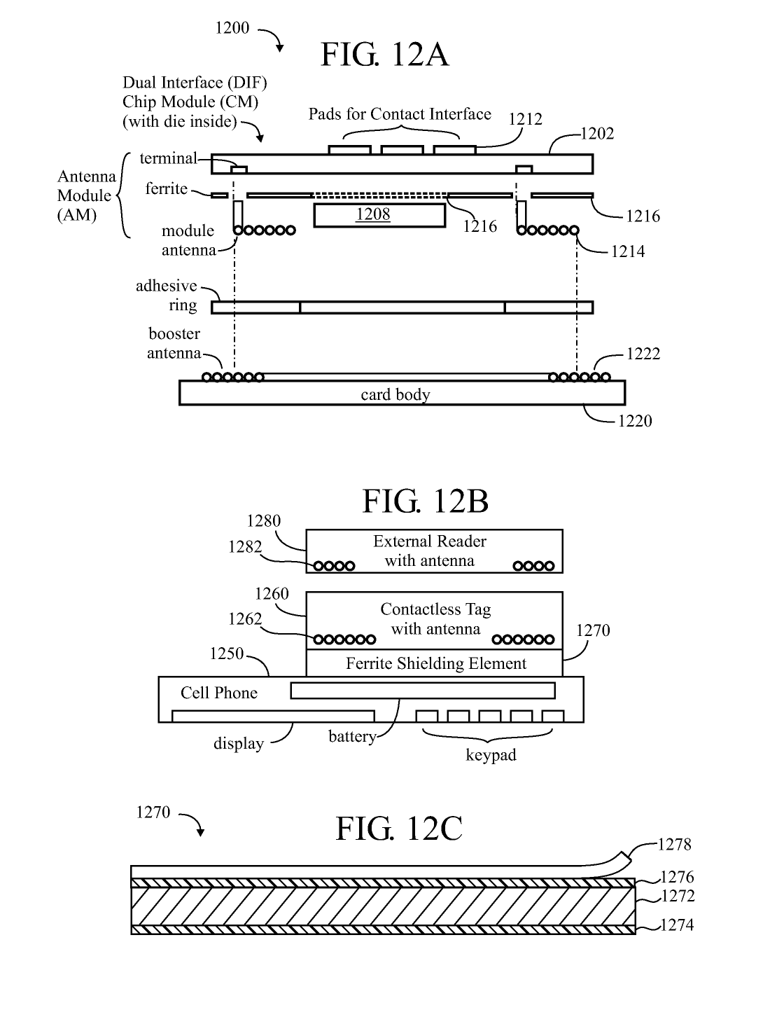

FIG. 12A shows an exemplary dual interface (DIF) smart card 1200 wherein a DIF chip module (CM) 1208 is mounted to an interconnection substrate 1202 having contact pads 1212 for a contact interface on one surface (top, as shown) thereof. An antenna (module antenna) 1214 is provided for contactless interface, and connected to the chip via the substrate 1202. The module antenna 1214 is typically on an opposite side (bottom, as shown) of the chip module 1208 than the contact pads 1212. Together, the substrate 1202, chip module 1208, contact pads 1212 and antenna 1214 (and ferrite element 1216, described below) may be referred to as “Antenna Module” (AM).

The DIF CM is mounted to a card body 1220 having a booster antenna 1222. In the contactless mode, the module antenna interacts with the booster antenna which, in turn interacts with the antenna (not shown) of an external reader (not shown). Some particulars may include . . .
the antenna module and module antenna are relatively small, such as 5 mm×5 mm
the card body and booster antenna are relatively large, such as 50 mm×80 mm
the module antenna may be substantially directly over a portion of the booster antenna (as shown in the figure), the remainder of the booster antenna may be distant from the chip module and module antenna.
the booster antenna may be made with conductive tracks or the like, in other words other than by embedding wire, which is the simplest “conventional” technique.

An exemplary construction of a DIF smart card may generally be as follows
an antenna module (AM) comprises a DIF chip module, pads for a contact interface on one surface thereof, and terminals for connecting a module antenna on another surface thereof
a small antenna (generally the size of the antenna module) is provided
the small antenna may be connected to the terminals of the antenna module
a large (booster, coupling) antenna is provided on the card body.
the antenna module AM may be mounted within the coupling (or booster) antenna so as to overlap one of its inner or outer antenna structures, as described hereinabove.
the booster antenna may be formed with a cutout so that 2 or 3 sides of the antenna module overlap the inner antenna structure (E) of the booster antenna.
an adhesive ring may be provided to secure the antenna module to the card body

The contact pads 1212 on the top side of the DIF module are metallic, and therefore may attenuate RF signals passing between the module antenna and the booster antenna. In order to alleviate the attenuation, and to enhance coupling between the module antenna and the booster antenna (and ultimately between the chip module and an external reader), a ferrite element 1216 may be disposed (interposed, inserted) between the chip module and the module antenna—or, in other words, between the contact pads 1212 and the module antenna 1214.

The ferrite element 1216 represents a passive magnetic element that increases the coupling between the antenna module antenna and the card body (booster) antenna, providing for example at least a +3 db increase in signal strength (in either direction, from the module antenna to the booster antenna, or from the booster antenna to the module antenna).

A channel or recess may be ablated in a card body to accept a ferrite material for shielding purposes.

A ferrite layer may be integrated into an inlay sandwich to produce a phone tag for payment purposes.

The ferrite element 1216 may be a separate layer of material, such from TDK or Kitagawa (see http://www.kitagawa.de/index.php?id=8&L=1).

The ferrite element 1216 may be sprayed onto the bottom surface of the chip module prior to installing the module antenna.

The ferrite element 1216 may be continuous (or contiguous, except for openings permitting connecting the antenna module through the ferrite element to the chip module), or may be discontinuous (for example, a grid or screen). As illustrated, an opening 1218 in the ferrite element/layer may be provided for the chip 1208 itself to be mounted to the substrate 1202.

The ferrite element 1216 may have a smooth surface, or may be rippled, or formed with a pattern of corner reflectors (like an egg carton) for enhancing coupling between the module antenna and the booster antenna.

The ferrite element 1216 may comprise nanostructures such as nanoparticles, nanowires or nanotubes.

Materials other than ferrite may be used for the ferrite element 1216. Any material, such as materials with high electromagnetic permeability, increasing the coupling (efficiency of energy transfer) between the module antenna and the booster antenna may be substituted for ferrite. The ferrite element 1216 may thus be referred to as “ferrite (or other)” element.

The ferrite (or other) element may be located other than between the module antenna and the chip module (contact pads), so long as the desired effect is achieved.

An additional or other ferrite (or other) element may be used to alleviate attenuation caused by metallic elements (such as the contact interface pads). For example, in the context of RFID stickers put on mobile (cell) phones, a ferrite (or other) element may be disposed between a contactless device and the cell phone. (The batteries of cell phones typically have a high metallic content).

To direct the flux field emanating from a high frequency RFID tag, a ferrite layer with high magnetic permeability can be integrated into an intermediate layer of a card body, with said layer hosting an area of resin with magnetic fillers, ferrite nanoparticles in a polymer or a sheet of sintered ferrite, for the purpose of reducing eddy current losses and to decouple the RFID tag from an underlying metal surface such as the metal casing of a battery in a mobile telephone. This shielding in the HF band prevents attenuation of the carrier wave (13.56 MHz) caused by inducing eddy currents on the metal surface of the battery. Without shielding, the eddy currents create a magnetic field reversing the direction of the carrier wave.

FIG. 12B illustrates a cell phone 1250 having a display and a keypad on its front surface (facing down in the figure), and containing a battery pack (“battery”). A contactless RFID device (“tag”) 1260 is disposed on the back (top, as viewed) surface of the phone. The Tag 1260 has an antenna 1262 inside for interacting with an external RFID reader 1280. The antenna 1262 may be the booster antenna mentioned above, or simply a sole antenna integral with the tag. The reader 1280 also has an antenna 1282 associated therewith, typically much larger than illustrated.

The tag 1260 is exemplary of a mobile phone sticker (MPS) which may be used for e-payment, e-ticketing, loyalty and access control applications.

A ferrite (or other suitable material) shielding element 1270 is disposed between the back of the cell phone 1250 and the RFID tag 1260 to alleviate attenuation of coupling between the tag and the reader. The element may be in the form of a film or tape, and may have adhesive on both sides for sticking the contactless tag to the phone. Double-sided tapes having adhesive on both sides are well known, such as for mounting carpets.

FIG. 12C shows a ferrite shielding element 1270 comprising:
a core layer (or substrate) 1272 which may be in the form of an elongate tape measuring a few centimeters wide and having two surfaces and having ferrite (or other) particles (including nanostructures) dispersed throughout
an adhesive layer 1274 on a bottom (as viewed) surface of the tape
an adhesive layer 1276 on a top (as viewed) surface of the tape, and
a release layer 1278 which will be peeled off and discarded, protecting the top adhesive layer 1276.

The shielding element is suitably delivered in roll form, similar to common double-back adhesive tape, and the release layer prevents the bottom adhesive layer 1274 from sticking to the top adhesive layer 1276 when the shielding tape 1270 is rolled up (in roll supply form).

### Nanowires & Nanotubes

Nanoparticles are mentioned above. When used herein, references to nanoparticles should be taken to include nanowires and nanotubes. Any of these may be referred to as “nanostructures”.

A nanowire (NW) is a nanostructure, with the diameter of the order of a nanometer (10-9 meters). Alternatively, nanowires can be defined as structures that have a thickness or diameter constrained to tens of nanometers or less and an unconstrained length. At these scales, quantum mechanical effects are important—which coined the term “quantum wires”. Many different types of nanowires exist, including metallic (e.g., Ni, Pt, Au), semiconducting (e.g., Si, InP, GaN, etc.), and insulating (e.g., SiO2, TiO2). Molecular nanowires are composed of repeating molecular units either organic (e.g. DNA) or inorganic (e.g. Mo6S9-xIx). Typical nanowires exhibit aspect ratios (length-to-width ratio) of 1000 or more. As such they are often referred to as one-dimensional (1-D) materials. Nanowires have many interesting properties that are not seen in bulk or 3-D materials. This is because electrons in nanowires are quantum confined laterally and thus occupy energy levels that are different from the traditional continuum of energy levels or bands found in bulk materials. The conductivity of a nanowire is expected to be much less than that of the corresponding bulk material. This is due to a variety of reasons. First, there is scattering from the wire boundaries, when the wire width is below the free electron mean free path of the bulk material. In copper, for example, the mean free path is 40 nm. Nanowires less than 40 nm wide will shorten the mean free path to the wire width. Nanowires also show other peculiar electrical properties due to their size. Unlike carbon nanotubes, whose motion of electrons can fall under the regime of ballistic transport (meaning the electrons can travel freely from one electrode to the other), nanowire conductivity is strongly influenced by edge effects. The edge effects come from atoms that lay at the nanowire surface and are not fully bonded to neighboring atoms like the atoms within the bulk of the nanowire. The unbonded atoms are often a source of defects within the nanowire, and may cause the nanowire to conduct electricity more poorly than the bulk material. As a nanowire shrinks in size, the surface atoms become more numerous compared to the atoms within the nanowire, and edge effects become more important.

High frequency (HF) antennas (13.56 MHz may include a plurality of nanowire heterostructures, such as core memory, inductive coils made of nanowires, antitheft devices based on nanowire structures, creating RFID tags on paper money to offset fraud.

Carbon nanotubes (CNTs) are allotropes of carbon with a cylindrical nanostructure. Nanotubes have been constructed with length-to-diameter ratio of up to 132,000,000:1,[1] significantly larger than for any other material. These cylindrical carbon molecules have unusual properties, which are valuable for nanotechnology, electronics, optics and other fields of materials science and technology. In particular, owing to their extraordinary thermal conductivity and mechanical and electrical properties, carbon nanotubes may find applications as additives to various structural materials.

Nanotubes are members of the fullerene structural family, which also includes the spherical buckyballs, and the ends of a nanotube may be capped with a hemisphere of the buckyball structure. Their name is derived from their long, hollow structure with the walls formed by one-atom-thick sheets of carbon, called graphene. These sheets are rolled at specific and discrete (“chiral”) angles, and the combination of the rolling angle and radius decides the nanotube properties; for example, whether the individual nanotube shell is a metal or semiconductor. Nanotubes are categorized as single-walled nanotubes (SWNTs) and multi-walled nanotubes (MWNTs). Individual nanotubes naturally align themselves into “ropes” held together by van der Waals forces. Because of the symmetry and unique electronic structure of graphene, the structure of a nanotube strongly affects its electrical properties. For a given (n,m) nanotube, if n=m, the nanotube is metallic; if n−m is a multiple of 3, then the nanotube is semiconducting with a very small band gap, otherwise the nanotube is a moderate semiconductor. Thus all armchair (n=m) nanotubes are metallic, and nanotubes (6,4), (9,1), etc. are semiconducting. In theory, metallic nanotubes can carry an electric current density of 4×109 A/cm2, which is more than 1,000 times greater than those of metals such as copper, where for copper interconnects current densities are limited by electromigration.

### Some Prior Art

U.S. Pat. No. 7,083,104 describes macroelectronic substrate materials incorporating nanowires. These are used to provide underlying electronic elements (e.g., transistors and the like) for a variety of different applications. Methods for making the macroelectronic substrate materials are disclosed. One application is for transmission a reception of RF signals in small, lightweight sensors. Such sensors can be configured in a distributed sensor network to provide security monitoring. Furthermore, a method and apparatus for a radio frequency identification (RFID) tag is described. The RFID tag includes an antenna and a beam-steering array. The beam-steering array includes a plurality of tunable elements. A method and apparatus for an acoustic cancellation device and for an adjustable phase shifter that are enabled by nanowires are also described.

U.S. Pat. No. 8,049,333 describes a transparent conductor including a conductive layer coated on a substrate is described. More specifically, the conductive layer comprises a network of nanowires which may be embedded in a matrix. The conductive layer is optically transparent and flexible. It can be coated or laminated onto a variety of substrates, including flexible and rigid substrates.

U.S. Pat. No. 7,985,632 describes a method for forming a wire in a layer based on a monocrystalline or amorphous material. The method forms two trenches in the layer, crossing through one face of the layer, separated from each other by one portion of the layer, by an etching of the layer on which is arranged an etching mask, and anneals, under hydrogenated atmosphere, the layer, the etching mask being maintained on the layer during the annealing. The depths and widths of the sections of the two trenches, and the width of a section of the portion of the layer, are such that the annealing eliminates a part of the portion of the layer, the two trenches then forming a single trench in which a remaining part of the portion of the layer forms the wire.

U.S. Pat. No. 7,960,653 describes an electrical interconnect includes first and second electrical contacts to be electrically connected, each electrical contact having a plurality of electrically conductive nanowires extending outwardly from a respective electrical contact; and the nanowires of the first electrical contact configured to mesh with the nanowires of the second electrical contact such that an electrical connection is established between the first electrical contact and the second electrical contact. A method for interconnecting electrical contacts includes meshing a first array of electrically conductive nanowires extending from a first electrical contact with a second array of electrically conductive nanowires extending from a second electrical contact so as to establish an electrical connection between said first and second electrical contacts.

U.S. Pat. No. 7,922,787 describes methods for the solution-based production of silver nanowires by adaptation of the polyol process. Some embodiments of the present invention can be practiced at lower temperature and/or at higher concentration than previously described methods. In some embodiments reactants are added in solid form rather than in solution. In some embodiments, an acid compound is added to the reaction.

U.S. Pat. No. 7,892,610 describes methods and systems for applying nanowires and electrical devices to surfaces are described. In a first aspect, at least one nanowire is provided proximate to an electrode pair. An electric field is generated by electrodes of the electrode pair to associate the at least one nanowire with the electrodes. The electrode pair is aligned with a region of the destination surface. The at least one nanowire is deposited from the electrode pair to the region. In another aspect, a plurality of electrical devices is provided proximate to an electrode pair. An electric field is generated by electrodes of the electrode pair to associate an electrical device of the plurality of electrical devices with the electrodes. The electrode pair is aligned with a region of the destination surface. The electrical device is deposited from the electrode pair to the region.

U.S. Pat. No. 7,833,616 describes a self-aligning nanowire which includes a nanowire portion and an aligning member attached to the nanowire portion. The aligning member interacts with another aligning member on an adjacent self-aligning nanowire to align the nanowires together. A method of aligning nanowires includes providing a plurality of the self-aligning nanowires, suspending the plurality in a carrier solution, and depositing the suspended plurality on a substrate. An ink formulation includes the plurality of suspended self-aligning nanowires in the carrier solution. A method of producing the self-aligning nanowire includes providing and associating the nanowire portion and the aligning member such that the nanowire produced is self-aligning with another nanowire.

U.S. Pat. No. 6,248,674 describes a method of aligning nanowires on a substrate. First, a plurality of the nanowires is formed on the substrate, then the plurality of nanowires is exposed to a flux of energetic ions, e.g., argon at an ion energy of 5 KV and an integrated flux density of about 6.times.10.sup.15 ions/cm.sup.2. The flux of energetic ions serves to align the nanowires parallel to each other. The flux of energetic ions may also be used to align the nanowires parallel to the substrate surface.

US 20110240344 describes the deposition of nanowires and other nanoparticles on surfaces. According to one aspect of the invention, a fluid containing nanoscale objects, such as nanowires, is deposited on a surface having one or more relatively hydrophilic regions and one or more relatively hydrophobic regions. If the fluid is hydrophilic, it will preferentially be located in the relatively hydrophilic regions (or vice versa if the fluid is relatively hydrophobic). The fluid is then allowed to evaporate to cause the nanoscale objects to deposit. For instance, the rate of evaporation may be controlled so as to allow the nanoscale objects to substantially deposit at the centers of the regions and/or at a rate that causes the nanoscale objects to become substantially aligned. In some cases, the regions may be relatively small, e.g., having a minimum surface dimension of less than about 3000 nm. In one set of embodiments, one or more cylindrical droplets may be formed on the surface. For example, the surface may contain a relatively hydrophilic region, having a large surface aspect ratio, surrounded by a relatively hydrophobic region, such that an aqueous fluid deposited on the relatively hydrophilic region forms a cylindrical droplet. Other aspects of the present invention are directed to methods for creating and using such articles, methods for promoting such articles, or the like.

US 20100148132 discloses a method suitable for large-scale producing silver nanostructures including nanoparticles and nanowires with high crystallization and purity in a short period of time. In this method, silver particles with mean diameter less than 200 nm and silver nanowires with length in micrometers are produced through a microwave-assisted wet chemistry method. Tens to hundreds grams of silver nanoparticles and nanowires are obtained in minutes by microwave irradiation treatment to a precursor pre-made by highly concentrated silver salt solution and other additives. These silver nanoparticles and nanowires have good dispersibility and are ideal for forming conductive adhesives.

US 20100126568 discloses a nanostructure including a first set of nanowires formed from filling a plurality of voids of a template. The nanostructure also includes a second set of nanowires formed from filling a plurality of spaces created when the template is removed, such that the second set of nanowires encases the first set of nanowires. Several methods are also disclosed. In one embodiment, a method of fabricating a nanostructure including nanowires is disclosed. The method may include forming a first set of nanowires in a template, removing a first portion of the template, thereby creating spaces between the first set of nanowires, forming a second set of nanowires in the spaces between the first set of nanowires, and removing a second portion of the template.

US 20100116780 describes a method for patterning nanowires on a substrate. The method includes procedures of preparing a substrate having a patterned sacrificial layer of barium fluoride thereon; growing nanowires on an entire surface of the resultant substrate including the patterned sacrificial layer; and removing the patterned sacrificial layer using a solvent to remove part of the nanowires on the patterned sacrificial layer such that part of the nanowires in direct contact with the substrate remains on the substrate to thereby form a nanowire pattern.

US 20080206936 describes a method of preparing an array of conducting or semi-conducting nanowires may include forming a vicinal surface of stepped atomic terraces on a substrate, and depositing a fractional layer of dopant material to form nanostripes having a width less than the width of the atomic terraces. Diffusion of the atoms of the dopant nanostripes into the substrate may form the nanowires.

Nanowire Networks to form an Antenna Structure

In an article dated March 2011 from Yang et al. titled “Silver Nanowires: From Scalable Synthesis to Recyclable Foldable Electronics”, the researchers focus on substrate materials that cater to the “chip-on-flex technologies” proposing various ways of creating conductive tracks using nanowires. They cite an article from Siegel et al. which demonstrates the feasibility of fabricating electrical circuits on paper for the purpose of foldable and disposable electronic devices, such as RFID tags.

Compared to the conventional printed circuit board (PCB) technology, paper offers a few advantages. For example, paper is inexpensive and can decompose easily; it is much thinner than the ordinary PCBs and can be folded, unfolded, and creased easily; electronics based on paper can be stored in smaller spaces or made to form 3D self-standing structures. However, because ordinary paper has a high average roughness (about 5 μm, which is related to the feature size of the cellulose fibers) and unique mechanical and thermal properties, an appropriate technique for fabricating the paper-based electronic devices needs to be developed to replace the current patterning technique used for PCBs.

Among the available printable conductive materials, Ag possesses excellent malleability, mechanical robustness, the highest electrical conductivity (1.6×10⁻⁶ Ωcm) among metals, and is highly resistant to corrosion. In particular, highly anisotropic silver nanowires (Ag NWs) have extra advantages in forming a percolated network when applied to rough surfaces (e.g., paper).

Compared to other materials, such as nanoparticle-based conductive inks and microflake-filled conductive adhesives, which suffer from the solution leaching problem on porous paper and more easily fail under serious strains (e.g., foldings), NWs are in a better position to be used as printable conductive materials. Moreover, Ag NWs are known to be safe to human beings compared to other non-metallic conductive materials (e.g., carbon nanotubes).

In their experiments, the researchers observed that on the rougher substrate surface, there was a higher electrical resistivity, which suggests that the rough surface disturbs the continuity of the associated Ag NW network. By adjusting the film thickness via controlling the solution concentration (Glycerol with a small dose of water), they achieved 2.6×10⁻⁵ Ωcm of the Ag NW film (film thickness=2 μm), which meets the requirements for many printed conductive adhesives and inks for micro-interconnect and printed resistor applications.

To further reduce the contact resistance among the NW network, they evaluated the possibility of hot laminating the Ag-NW based paper circuits (at 125° C.) rather than sintering them. Sequential hot laminations resulted in a decrease in electrical resistance of approximately 10-20% of the samples. Moreover, they observed that this process is particularly effective for thicker Ag NW films, which may be related to the more evenly distributed Ag NWs in the circuits. The smoother the substrate surface, the more effective in the reduction of electrical resistance by the hot-laminations, which confirms the observation that the Ag NWs are compatible with the roughness of the paper substrate.

In summary, conductive films formed by the Ag NWs exhibit electrical conductivity (≈5×10⁶ S m⁻¹), which is close to that of eutectic solders, rendering them a competitive alternative as the electric current carrier.

In another academic article titled “Spray Deposition of Highly Transparent, Low-Resistance Networks of Silver Nanowires over Large Areas”, Scardaci et al. describe a method to produce scalable, low-resistance, high-transparency, percolating networks of silver nanowires by spray coating. By optimizing the spraying parameters, networks with a sheet resistance of R s≈50 Ω□⁻¹ at a transparency of T=90% can be produced. The critical processing parameter is shown to be the spraying pressure. Optimizing the pressure reduces the droplet size resulting in more uniform networks. High uniformity leads to a low percolation exponent, which is essential for low-resistance, high-transparency films.

The researchers used AgNWs with an approximate diameter of 60 nm from Seashell Technologies (www.seashelltech.com). The wires were provided as a dispersion in isopropanol and stabilized by a propriety organic coating. The pristine dispersion was diluted with water to a concentration of approximately 0.1 mg/mL before use. Films were formed by spraying the diluted dispersion onto the substrate of choice (PET) using an airbrush (Infinity, Harder & Steenbeck GmbH). The airbrush was vertically mounted on a computer-controlled, three axis gantry several centimeters above the substrate, which was resting on a hotplate. The dispersion was atomized into very small droplets using pressurized air to create a velocity gradient as the liquid was passed through the nozzle of the airbrush. Keeping the nozzle to PET distance constant, the airbrush spray was moved in a set pattern with respect to the substrate. This pattern was repeated several times until the required network thickness was achieved.

While the invention has been described with respect to a limited number of embodiments, these should not be construed as limitations on the scope of the invention, but rather as examples of some of the embodiments. Those skilled in the art may envision other possible variations, modifications, and implementations that are also within the scope of the invention, based on the disclosure(s) set forth herein.

What is claimed is:

1. A method of forming microstructures and antennas for RFID transponders comprising:
coating a surface of a substrate with nanostructures; and
modifying a portion of the medium to form a conductive track.

2. The method of claim 1, further comprising:
forming at least one channel in a surface of the substrate.

3. The method of claim 2, further comprising:
depositing nanostructures while forming the channel.

4. The method of claim 1, wherein:
the at least one channel is formed by laser ablation.

5. The method of claim 1, wherein:
the substrate comprises a polymer.

6. The method of claim 1, wherein:
the substrate is an inlay substrate for a secure document.

7. The method of claim 1, further comprising:
the nanostructures are from the group consisting of nanoparticles, nanowires and nanotubes.

8. A method of connecting an antenna wire to a chip or chip module on a transponder substrate comprising:
designating two portions of the substrate as enlarged connection portions;
forming channels in each of the enlarged connection portions for receiving end portions of the antenna wire;
coating the connection portions including the channels with conductive nanoparticles; and
laying the end portions of the antenna wire in the channels.

9. The method of claim 8, further comprising:
disposing the chip or chip module onto the substrate with its terminals facing down, each terminal area received by a respective one of the enlarged connection portions.

10. The method of claim 8, further comprising:
prior to coating the connection portions, forming depressions in each of the enlarged connection portions of the substrate for receiving a respective one of the terminals of the chip or chip module.

11. A method of mounting an RFID tag to a cell phone comprising:
disposing a shielding element between the RFID tag and the cell phone.

12. The method of claim 11, wherein the shielding element comprises:
a core layer having two surfaces and having ferrite particles; and
adhesive layers on the two surfaces of the core layer.

13. The method of claim 11, wherein the shielding element further comprises:
a release layer.

14. The method of claim 11, wherein:
the core layer is in the form of an elongate tape.

15. The method of claim 14, wherein:
the tape is supplied in roll form.

16. The method of claim 11, wherein:
the RFID tag comprises a smart mobile phone sticker (MPS).
